(19) United States
(12) Patent Application Publication
(10) Pub. No.: US 2011/0288835 A1
(43) Pub. Date: Nov. 24, 2011

(54) DATA PROCESSING DEVICE, DATA PROCESSING METHOD AND PROGRAM

(76) Inventors: Takashi Hasuo, Tokyo (JP); Kenta Kawamoto, Tokyo (JP)

(21) Appl. No.: 13/106,071

(22) Filed: May 12, 2011

(30) Foreign Application Priority Data
May 20, 2010 (JP) P2010-116092

(51) Int. Cl. G06F 17/10

(52) U.S. Cl. 703/2

(57) ABSTRACT

A data processing device includes a parameter estimation unit and a structure adjustment unit. The structure adjustment unit notes each state of an HMM as a noted state, obtains, for the noted state, a value corresponding to an eigen value difference which is a difference between a partial eigen value sum and a total eigen value sum, as a target degree value indicating a degree for selecting the noted state as a division target or a mergence target, selects a state having the target degree value larger than a division threshold value, as a division target, and selects a state having the target degree value smaller than a mergence threshold value, as a mergence target.

### BACKGROUND OF THE INVENTION

1. Field of the Invention

The present invention relates to a data processing device, a data processing method, and a program, and more particularly to a data processing device, a data processing method, and a program, capable of obtaining an HMM which appropriately represents, for example, a modeling target.

2. Description of the Related Art

Based on a sensor signal observed from a target for modeling (hereinafter, referred to as a modeling target), that is, a sensor signal which is obtained as a result of sensing of the modeling target, as learning methods used for constituting states of the modeling target, there has been proposed, for example, a K-means clustering method or an SOM (self-organization map).

In the K-means clustering method or the SOM, the states are arranged as representative vectors on a signal space of the observed sensor signal.

In the K-means clustering method, for initialization, representative vectors are appropriately arranged on the signal space. In addition, a vector of the sensor signal at each time is allocated to a closest representative vector, and the representative vector is repeatedly updated by an average vector of vectors allocated to the respective representative vectors.

In the SOM, a competitive neighborhood learning is used for learning for representative vectors.

In studies on the SOM, a learning method called a growing grid has been widely proposed in which states (here, representative vectors) are gradually increased and are learned.

In the K-means clustering method or the SOM, the states (representative vectors) are arranged on the signal space, but information regarding how the states are transited is not learned.

For this reason, it is difficult to handle a problem called perceptual aliasing in the K-means clustering method or the SOM.

Here, the perceptual aliasing refers to a problem in that despite there being different states of a modeling target, if sensor signals observed from the modeling target are the same, they may not be discriminated. For example, in a case where a movable robot provided with a camera observes scenery images as sensor signals through the camera, if there are many places where the same scenery image is observed in an environment, there is a problem in that they may not be discriminated.

On the other hand, use of an HMM (Hidden Markov Model) has been proposed as a learning method in which an observed sensor signal is treated as time series data and is learned as a probability model having both states and state transition.

The HMM is one of a number of models widely used for speech recognition, and is a state transition probability model which is defined by a state transition probability indicating state transition, or a probability distribution (which is a probability value of a discrete value if the observed value is a discrete value, and is a probability density function indicating a probability density if the observed value is a continuous value, etc.) in which a certain observed value is observed when a state is transited in each state.

The parameter of the HMM, that is, the state transition probability, the probability distribution, or the like is estimated so as to maximize likelihood. As an estimation method of the HMM parameter, a Baum-Welch algorithm is widely used.

In addition, as an estimation method of the HMM parameter, for example, there is a Monte-Carlo EM (Expectation-Maximization) algorithm or a mean field approximation.

The HMM is a state transition probability model in which each state can be transited to other states via the state transition probability, and, according to the HMM, a modeling target (a sensor signal observed therefrom) is modeled as a procedure where a state is transited.

However, in the HMM, generally, to which state an observed sensor signal corresponds is determined only by probability. Therefore, as a method of determining a state transition procedure in which the likelihood is the highest, that is, a state sequence which maximizes the likelihood (hereinafter, also referred to as a maximum likelihood path) based on an observed sensor signal, a Viterbi algorithm is widely used.

By the Viterbi algorithm, a state corresponding to a sensor signal at each time can be specified along the maximum likelihood path.

According to the HMM, even if sensor signals observed from a modeling target are the same in different situations (states), the same sensor signal can be treated as different state transition procedures due to a difference in time variable procedures of the sensor signals before and after that time.

In addition, the HMM does not completely solve the perceptual aliasing problem, but can model a modeling target more specifically (appropriately) than the SOM or the like, since different states are allocated to the same sensor signals.

Meanwhile, in the learning for the HMM, if the number of states and the number of state transitions become large, a parameter is difficult to appropriately (correctly) estimate.

Particularly, the Baum-Welch algorithm does not guarantee to determine an optimal parameter, and thus if the number of parameters increases, it is very difficult to determine an appropriate parameter.

In addition, when a modeling target is an unknown target, it is not easy to appropriately set a structure of the HMM or an initial value of a parameter, and this is a factor which makes it difficult to estimate an appropriate parameter.

The reason why the HMM is effectively used for speech recognition is that a treated sensor signal is limited to a speech signal, a large amount of knowledge regarding speech can be used, and a structure of the HMM for appropriately modeling speech can use a left-to-right structure, and the like, which have been obtained as a result of studies over a long period.

Therefore, in a case where a modeling target is an unknown target and information for determining a structure of the HMM or an initial value is not given in advance, it is a very difficult to enable the HMM (which may have a large scale) to function as a practical model.

In addition, there has been proposed a method of determining a structure of the HMM by using an evaluation criterion called Akaike's information criteria (called AIC) without giving a structure of the HMM in advance.

In the method using the AIC, a parameter is estimated each time the number of states of the HMM or the number of state transitions is increased by one, and a structure of the HMM is determined by repeatedly evaluating the HMM using the AIC as an evaluation criterion.

The method using the AIC is applied to an HMM of a small scale such as a phonemic model.

However, the method using the AIC does not consider parameter evaluation for a large scale HMM, and thereby it is difficult to appropriately model a complicated modeling target.

In other words, since a structure of the HMM is corrected only by adding one state and one state transition, monotonic improvement in the evaluation criterion is not necessarily guaranteed.

Therefore, even if the method using the AIC is applied to a complicated modeling target represented by the large scale HMM, an appropriate HMM structure may not be determined.

Thereby, the present applicant has previously proposed a learning method capable of obtaining a state transition probability model such as an HMM or the like which appropriately models a modeling target even if the modeling target is complicated (for example, refer to Japanese Unexamined Patent Application Publication No. 2009-223443).

In the method disclosed in the Japanese Unexamined Patent Application Publication No. 2009-223443, an HMM is learned while time series data and a structure of the HMM are adjusted.

### SUMMARY OF THE INVENTION

There are demands for various methods for obtaining an HMM which appropriately models a modeling target, that is, an HMM which appropriately represents a modeling target.

It is desirable to obtain an HMM which appropriately represents a modeling target.

According to an embodiment of the present invention, there is provided a data processing device including or a program enabling a computer to function as a data processing device including a parameter estimation means that performs parameter estimation for estimating parameters of an HMM (Hidden Markov Model) using time series data; and a structure adjustment means that selects a division target which is a state to be divided and a mergence target which is a state to be merged from states of the HMM, and performs structure adjustment for adjusting a structure of the HMM by dividing the division target and merging the mergence target, wherein the structure adjustment means notes each state of the HMM as a noted state; obtains, for the noted state, a value corresponding to an eigen value difference which is a difference between a partial eigen value sum which is a sum of eigen values of a partial state transition matrix excluding a state transition probability from the noted state and a state transition probability to the noted state from a state transition matrix having state transition probabilities from each state to each state of the HMM as components, and a total eigen value sum which is a sum of eigen values of the state transition matrix, as a target degree value indicating a degree for selecting the noted state as the division target or the mergence target; and selects a state having the target degree value larger than a division threshold value which is a threshold value larger than an average value of target degree values of all the states of the HMM, as the division target, and selects a state having the target degree value smaller than a mergence threshold value which is a threshold value smaller than an average value of target degree values of all the states of the HMM, as the mergence target.

According to an embodiment of the present invention, there is provided a data processing method including the steps of causing a data processing device to perform parameter estimation for estimating parameters of an HMM (Hidden Markov Model) using time series data; and to select a division target which is a state to be divided and a mergence target which is a state to be merged from states of the HMM, and to perform structure adjustment for adjusting a structure of the HMM by dividing the division target and merging the mergence target, wherein the structure adjustment step includes noting each state of the HMM as a noted state; obtaining, for the noted state, a value corresponding to an eigen value difference which is a difference between a partial eigen value sum which is a sum of eigen values of a partial state transition matrix excluding a state transition probability from the noted state and a state transition probability to the noted state from a state transition matrix having state transition probabilities from each state to each state of the HMM as components, and a total eigen value sum which is a sum of eigen values of the state transition matrix, as a target degree value indicating a degree for selecting the noted state as the division target or the mergence target; and selecting a state having the target degree value larger than a division threshold value which is a threshold value larger than an average value of target degree values of all the states of the HMM, as the division target, and selecting a state having the target degree value smaller than a mergence threshold value which is a threshold value smaller than an average value of target degree values of all the states of the HMM, as the mergence target.

According to the above-described configuration, parameter estimation for estimating parameters of an HMM (Hidden Markov Model) using time series data is performed, a division target which is a state to be divided and a mergence target which is a state to be merged are selected from states of the HMM, and structure adjustment for adjusting a structure of the HMM by dividing the division target and merging the mergence target is performed. In the structure adjustment, each state of the HMM as a noted state is noted, and, for the noted state, there is an obtainment of a value corresponding to an eigen value difference which is a difference between a partial eigen value sum which is a sum of eigen values of a partial state transition matrix excluding a state transition probability from the noted state and a state transition probability to the noted state from a state transition matrix having state transition probabilities from each state to each state of the HMM as components, and a total eigen value sum which is a sum of eigen values of the state transition matrix, as a target degree value indicating a degree for selecting the noted state as the division target or the mergence target. In addition, a state having the target degree value larger than a division threshold value which is a threshold value larger than an average value of target degree values of all the states of the HMM is selected as the division target, and a state having the target degree value smaller than a mergence threshold value which is a threshold value smaller than an average value of target degree values of all the states of the HMM is selected as the mergence target.

According to another embodiment of the present invention, there is provided a data processing device including or a program enabling a computer to function as a data processing device including a parameter estimation means that performs parameter estimation for estimating parameters of an HMM (Hidden Markov Model) using time series data; and a structure adjustment means that selects a division target which is a state to be divided and a mergence target which is a state to be merged from states of the HMM, and performs structure adjustment for adjusting a structure of the HMM by dividing the division target and merging the mergence target, wherein the structure adjustment means notes each state of the HMM as a noted state; obtains, for the noted state, an average state probability which is obtained by averaging a state probability of the noted state in a time direction when a sample of the time series data at each time is observed, as a target degree value indicating a degree for selecting the noted state as the division target or the mergence target; and selects a state having the target degree value larger than a division threshold value which is a threshold value larger than an average value of target degree values of all the states of the HMM, as the division target, and selects a state having the target degree value smaller than a mergence threshold value which is a threshold value smaller than an average value of target degree values of all the states of the HMM, as the mergence target.

According to another embodiment of the present invention, there is provided a data processing method including the steps of causing a data processing device to perform parameter estimation for estimating parameters of an HMM (Hidden Markov Model) using time series data; and to select a division target which is a state to be divided and a mergence target which is a state to be merged from states of the HMM, and to perform structure adjustment for adjusting a structure of the HMM by dividing the division target and merging the mergence target, wherein the structure adjustment step includes noting each state of the HMM as a noted state; obtaining, for the noted state, an average state probability which is obtained by averaging a state probability of the noted state in a time direction when a sample of the time series data at each time is observed, as a target degree value indicating a degree for selecting the noted state as the division target or the mergence target; and selecting a state having the target degree value larger than a division threshold value which is a threshold value larger than an average value of target degree values of all the states of the HMM, as the division target, and selecting a state having the target degree value smaller than a mergence threshold value which is a threshold value smaller than an average value of target degree values of all the states of the HMM, as the mergence target.

According to another configuration described above, parameter estimation for estimating parameters of an HMM (Hidden Markov Model) is performed using time series data, a division target which is a state to be divided and a mergence target which is a state to be merged from states of the HMM are selected, and structure adjustment for adjusting a structure of the HMM is performed by dividing the division target and merging the mergence target. In the structure adjustment, each state of the HMM as a noted state is noted; for the noted state, there is an obtainment of an average state probability which is obtained by averaging a state probability of the noted state in a time direction when a sample of the time series data at each time is observed, as a target degree value indicating a degree for selecting the noted state as the division target or the mergence target; a state having the target degree value larger than a division threshold value which is a threshold value larger than an average value of target degree values of all the states of the HMM, is selected as the division target, and a state having the target degree value smaller than a mergence threshold value which is a threshold value smaller than an average value of target degree values of all the states of the HMM, is selected as the mergence target.

In addition, the data processing device may be a standalone device or may be internal blocks constituting a single device.

Also, the program may be provided by being transmitted via a transmission medium or being recorded in a recording medium.

According to the present invention, it is possible to obtain an HMM which appropriately represents a modeling target.

### BRIEF DESCRIPTION OF THE DRAWINGS

FIG. 1 is a diagram illustrating an outline of a configuration example of a data processing device according to an embodiment.

FIG. 2 is a diagram illustrating an example of an ergodic HMM.

FIG. 3 is a diagram illustrating an example of a left-to-right type HMM.

FIG. 4 is a block diagram illustrating a detailed configuration example of the data processing device.

FIG. 5 is a diagram illustrating division of states.

FIG. 6 is a diagram illustrating mergence of states.

FIG. 7 is a diagram illustrating observed time series data as learning data used to learn an HMM, which is simulated to select a division target and a mergence target.

FIGS. 8A to 8D are diagrams illustrating a simulation result for selecting a division target and a mergence target.

FIG. 9 is a diagram illustrating selection of a division target and a mergence target which is performed using an average state probability as a target degree value.

FIG. 10 is a diagram illustrating selection of a division target and a mergence target which is performed using an average state probability as a target degree value.

FIG. 11 is a diagram illustrating selection of a division target and a mergence target which is performed using an eigen value difference as a target degree value.

FIG. 12 is a diagram illustrating selection of a division target and a mergence target which is performed using an eigen value difference as a target degree value.

FIG. 13 is a diagram illustrating selection of a division target and a mergence target which is performed using a synthesis value as a target degree value.

FIG. 14 is a diagram illustrating selection of a division target and a mergence target which is performed using a synthesis value as a target degree value.

FIG. 15 is a flowchart illustrating a learning process in the data processing device.

FIG. 16 is a flowchart illustrating a structure adjustment process.

FIG. 17 is a diagram illustrating a first simulation for the learning process.

FIG. 18 is a diagram illustrating a relationship between the number of learnings and likelihood (log likelihood) for an HMM in the learning for the HMM as the first simulation.

FIG. 19 is a diagram illustrating a second simulation for the learning process.

FIG. 20 is a diagram illustrating a relationship between the number of learnings and likelihood (log likelihood) for an HMM in the learning for the HMM as the second simulation.

FIG. 21 is a diagram schematically illustrating a state where a good solution which is a parameter of the HMM appropriately representing a modeling target is efficiently searched for in a solution space.

FIG. 22 is a block diagram illustrating a configuration example of a computer according to an embodiment of the present invention.

### DESCRIPTION OF THE PREFERRED EMBODIMENTS

### Outline of Data Processing Device According to Embodiment

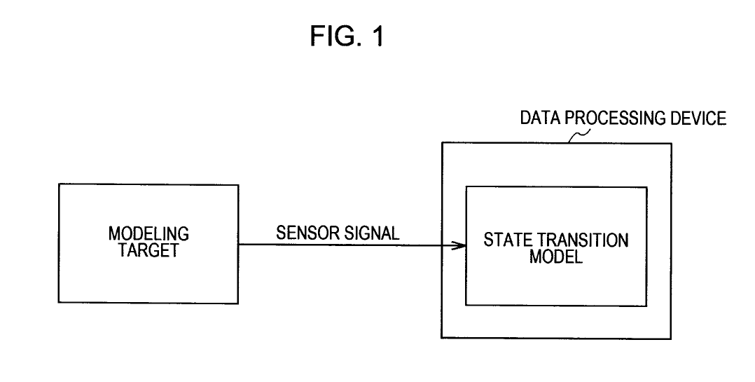

FIG. 1 is a diagram illustrating an outline of a configuration example of a data processing device according to an embodiment of the present invention.

In FIG. 1, the data processing device stores a state transition probability model including states and state transitions. The data processing device functions as a learning device which performs learning for modeling a modeling target using the state transition probability model.

A sensor signal obtained by sensing a modeling target is observed, for example, in a time series from the modeling target.

The data processing device learns the state transition probability model using the sensor signal observed from the modeling target, that is, here, estimates parameters of the state transition probability model and determines a structure.

Here, as the state transition probability model, for example, an HMM, a Bayesian network, POMDP (Partially Observable Markov Decision Process), or the like may be used. Hereinafter, as the state transition probability model, for example, the HMM is used.

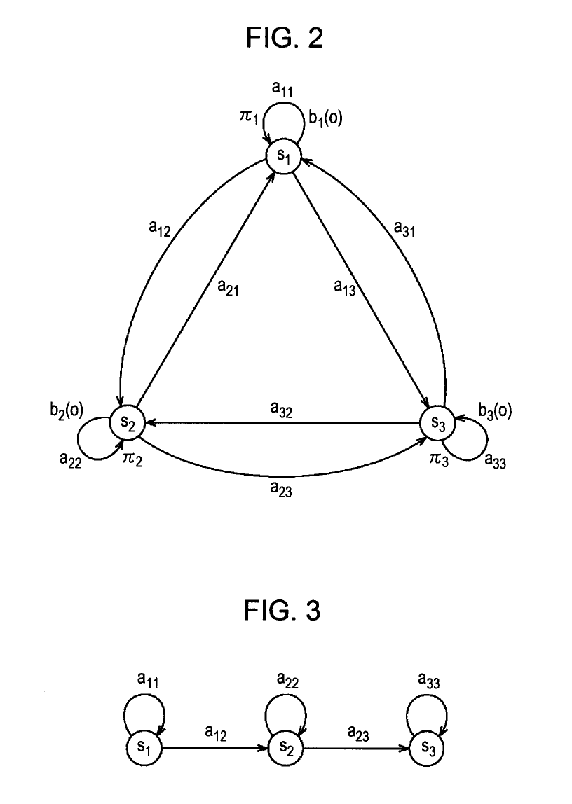

FIG. 2 is a diagram illustrating an example of the HMM.

The HMM is a state transition probability model including states and state transitions.

FIG. 2 shows an example of the HMM having three states.

In FIG. 2 (the same is true of FIG. 3), the circle denotes a state, and the arrow denotes a state transition.

In addition, in FIG. 2, sᵢ (in FIG. 2, i=1, 2 and 3) denotes a state, and aᵢⱼ denotes a state transition probability (of a state transition) from a state sᵢ to a state sⱼ. In addition, bⱼ(o) denotes a probability distribution where an observed value o is observed in a state sⱼ, and πᵢ denotes an initial probability in which the state sᵢ is in an initial state.

If the observed value o is a discrete value, the probability distribution bⱼ(o) is a discrete probability value where the observed value o which is the discrete value is observed, and if the observed value o is a continuous value, the probability distribution bⱼ(o) is a probability density function indicating a probability density where the observed value o which is the continuous value is observed.

As the probability density function, for example, a mixture normal probability distribution may be used.

Here, the HMM is defined by the state transition probability aᵢⱼ, the probability distribution bⱼ(o), and the initial probability πᵢ. Therefore, the state transition probability aᵢⱼ, the probability distribution bⱼ(o), and the initial probability πᵢ are parameters λ={aᵢⱼ, bⱼ(o), πᵢ, i=1, 2, . . . , N, j=1, 2, . . . , N} of the HMM. N denotes the number of states of the HMM.

As a method for estimating the parameters λ of the HMM, as described above, for example, the Baum-Welch algorithm is widely used. The Baum-Welch algorithm is a parameter estimation method based on the EM (Expectation-Maximization) algorithm.

According to the Baum-Welch algorithm, the parameters λ of the HMM are estimated such that a likelihood obtained from an occurrence probability which is a probability that time series data o is observed (occurs) based on the observed time series data o=o₁, o₂, . . . , o_{T} is maximized.

Here, oₜ denotes an observed value (sample value of a sensor signal) observed at time t, and T denotes a length of the time series data (the number of samples).

In addition, the Baum-Welch algorithm is a parameter estimation method based on the likelihood maximization, not guaranteeing optimality, but has an initial value dependency since it converges to a local solution depending on a structure of the HMM or initial values of the parameters λ.

The HMM is widely used for speech recognition, but the number of states, a state transition method or the like is determined in advance in the HMM used for the speech recognition.

FIG. 3 is a diagram illustrating an example of the HMM used for the speech recognition.

The HMM in FIG. 3 is also called a left-to-right type HMM.

In FIG. 3, the number of states is 3, and the state transition is limited to a structure which allows a self transition (a state transition from a state sᵢ to the state sᵢ) and a state transition from a certain state to a state positioned at the further right than the certain state.

Unlike the HMM in FIG. 3, which has a limitation in the state transition, an HMM which has no limitation in the state transition shown in FIG. 2, that is, where a state transition from an arbitrary state sᵢ to an arbitrary sⱼ is possible is called an ergodic HMM.

The ergodic HMM is an HMM having a structure with a highest degree of freedom, but, if the number of states increases, it is difficult to estimate the parameters λ.

For example, if the number of the states of the ergodic HMM is 100, the number of state transitions is ten thousand (=100×100). Therefore, in this case, regarding, for example, the state transition probability aᵢⱼ among the parameters λ, it is necessary to estimate ten thousand state transition probabilities aᵢⱼ.

In addition, for example, if the number of states of the ergodic HMM is 1000, the number of state transitions is one million (=1000×1000). Therefore, in this case, regarding, for example, the state transition probability aᵢⱼ among the parameters λ, it is necessary to estimate one million state transition probabilities aᵢⱼ.

Limited state transitions are sufficient for necessary state transitions according to a modeling target, but, if a best way to limit state transitions is unknown beforehand, it is very difficult to appropriately estimate such a large number of the parameters λ. In addition, if an appropriate number of states is unknown beforehand and if information for deciding a structure of the HMM is also unknown beforehand, it is also difficult to obtain appropriate parameters λ.

In other words, for example, if, in an HMM having one hundred states, transition destinations of state transitions for the respective states are limited to five including a self transition, the state transition probability aᵢⱼ to be estimated can be reduced to five hundred from ten thousand in the case where the state transitions are not limited.

However, when state transitions are limited after the number of states of the HMM is fixed, the HMM is notable in the initial value dependency due to damage of flexibility of the HMM, and thus it is difficult to obtain appropriate parameters, that is, obtain an HMM appropriately representing a modeling target.

The data processing device in FIG. 1 carries out learning for estimation of parameters λof an HMM while determining an appropriate structure of the HMM to a modeling target even if a structure of the HMM, that is, the number of states and state transitions of the HMM are not limited beforehand.

### Configuration Example of Data Processing Device According to Embodiment

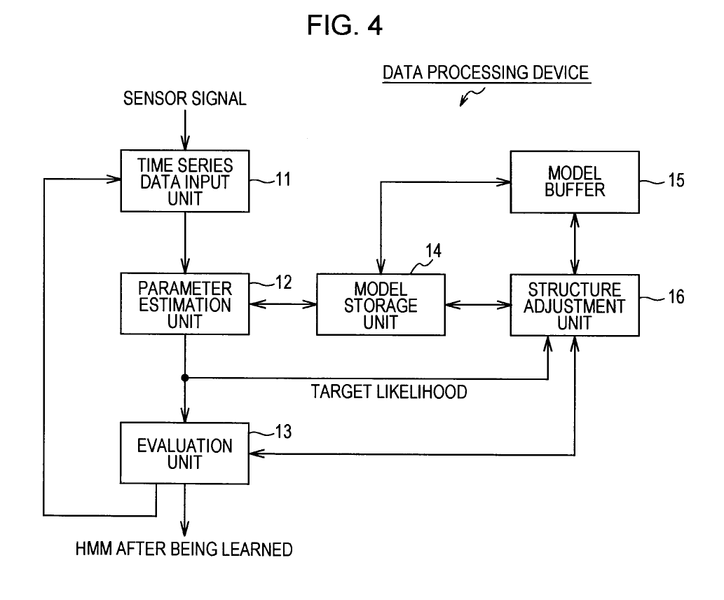

FIG. 4 is a block diagram illustrating a configuration example of the data processing device in FIG. 1.

In FIG. 4, the data processing device includes a time series data input unit 11, a parameter estimation unit 12, an evaluation unit 13, a model storage unit 14, a model buffer 15, and a structure adjustment unit 16.

The time series data input unit 11 receives a sensor signal observed from a modeling target. The time series data input unit 11 outputs time series data (hereinafter, also referred to as observed time series data) o=o₁, o₂, o_{T} observed from the modeling target, based on the sensor signal observed from the modeling target, to the parameter estimation unit 12.

In other words, the time series data input unit 11, for example, normalizes the time series sensor signals observed from the modeling target to a predetermined range of signals which are supplied to the parameter estimation unit 12 as observed time series data o.

In addition, the time series data input unit 11 supplies the observed time series data o to the parameter estimation unit 12 in response to a request from the evaluation unit 13.

The parameter estimation unit 12 estimates parameters λ of the HMM stored in the model storage unit 14 using the observed time series data o from the time series data input unit 11.

In other words, the parameter estimation unit 12 performs a parameter estimation for estimating new parameters λ of the HMM stored in the model storage unit 14 by, for example, the Baum-Welch algorithm, using the observed time series data o from the time series data input unit 11.

The parameter estimation unit 12 supplies the new parameters λ obtained by the parameter estimation for the HMM to the model storage unit 14 and stores the parameters λ in an overwrite manner.

In addition, the parameter estimation unit 12 uses values stored in the model storage unit 14 as initial values of the parameters λ when estimating the parameters λ of the HMM.

Here, in the parameter estimation unit 12, the process for estimating the new parameters λ is counted as one in the number of learnings.

The parameter estimation unit 12 increases the number of learnings by one each time new parameters λ are estimated, and supplies the number of learnings to the evaluation unit 13.

In addition, the parameter estimation unit 12 obtains a likelihood where the observed time series data o from the time series data input unit 11 is observed, from the HMM defined by the new parameters λ, and supplies the likelihood or a log likelihood obtained by applying a logarithm to the likelihood to the evaluation unit 13 and the structure adjustment unit 16.

The evaluation unit 13 evaluates the HMM which has been learned, that is, the HMM for which the parameters λ have been estimated in the parameter estimation unit 12, based on the likelihood or the number of learnings from the parameter estimation unit 12, and determines whether to perform structure adjustment for adjusting a structure of the HMM stored in the model storage unit 14 or to finish learning for the HMM, according to the HMM evaluation result.

In other words, the evaluation unit 13 evaluates characteristics (times series pattern) of the observed time series data o using the HMM to be insufficiently obtained until the number of learnings from the parameter estimation unit 12 reaches a predetermined number, and determines the learning for the HMM as continuing.

In addition, if the number of learnings from the parameter estimation unit 12 reaches a predetermined number, the evaluation unit 13 evaluates characteristics of the observed time series data o using the HMM to be sufficiently obtained, and determines the learning for the HMM as being finished.

Alternatively, the evaluation unit 13 evaluates characteristics (times series pattern) of the observed time series data o using the HMM to be insufficiently obtained until the likelihood from the parameter estimation unit 12 reaches a predetermined value, and determines the learning for the HMM as continuing.

In addition, if the likelihood from the parameter estimation unit 12 reaches a predetermined value, the evaluation unit 13 evaluates characteristics of the observed time series data o using the HMM to be sufficiently obtained, and determines the learning for the HMM as being finished.

If determining the learning for the HMM as continuing, the evaluation unit 13 requests the time series data input unit 11 to supply the observed time series data.

On the other hand, if determining the learning for the HMM as being finished, the evaluation unit 13 reads an HMM as a best model described later, which is stored in the model buffer 15 via the structure adjustment unit 16, and outputs the read HMM as an HMM after being learned (HMM representing a modeling target from which the observed time series data is observed).

In addition, the evaluation unit 13 obtains an increment of likelihood where observed time series data is observed in an HMM after parameters are estimated with respect to a likelihood where observed time series data is observed in an HMM before the parameters are estimated, using the likelihood from the parameter estimation unit 12, and determines a structure of the HMM as being adjusted if the increment is smaller than a predetermined value (equal to or smaller than the predetermined value).

On the other hand, the evaluation unit 13 determines a structure of the HMM as not being adjusted if the increment of the likelihood where observed time series data is observed in the HMM after the parameters are estimated is not smaller than the predetermined value.

Further, if determining a structure of the HMM as being adjusted, the evaluation unit 13 requests the structure adjustment unit 16 to adjust a structure of the HMM stored in the model storage unit 14.

The model storage unit 14 stores, for example, an HMM which is a state transition probability model.

In other words, if new parameters of an HMM are supplied from the parameter estimation unit 12, the model storage unit 14 updates (overwrites) stored values (stored parameters of the HMM) to the new parameters.

In addition, the HMM (the parameters thereof) stored in the model storage unit 14 are also updated by the structure adjustment of the HMM by the structure adjustment unit 16.

Under the control of the structure adjustment unit 16, the model buffer 15 stores in the model storage unit 14 an HMM in which likelihood in which observed time series data is observed is maximized, of HMMs (parameters therefor) stored in the model storage unit 14, as a best model most appropriately representing a modeling target from which the observed time series data is observed.

The structure adjustment unit 16 performs the structure adjustment for adjusting a structure of the HMM stored in the model storage unit 14 in response to the request from the evaluation unit 13.

In addition, the structure adjustment for the HMM performed by the structure adjustment unit 16 includes adjustment of parameters of the HMM which is necessary for the structure adjustment.

Here, a structure of the HMM is determined by the number of states constituting the HMM and state transitions between states (state transitions of which the state transition probability is not 0.0). Therefore, the structure of the HMM can refer to the number of states and state transitions of the HMM.

A kind of structure adjustment of the HMM performed by the structure adjustment unit 16 includes a division of states and a mergence of states.

The structure adjustment unit 16 selects a division target which is a state of a target to be divided and a mergence target which is a state of a target to be merged from states of the HMM stored in the model storage unit 14, and performs the structure adjustment by dividing the division target (which is a state) and merging the mergence target (which is a state).

In the division of a state, the number of the HMM increases in order to expand a scale of the HMM, thereby appropriately representing a modeling target. On the other hand, in the mergence of a state, the number of states decreases due to removal of redundant states, thereby appropriately representing a modeling target. In addition, according to the variation in the number of the states of the HMM, the number of state transitions also varies.

The structure adjustment unit 16 controls a best model to be stored in the model buffer 15 based on the likelihood supplied from the parameter estimation unit 12.

### Division of State

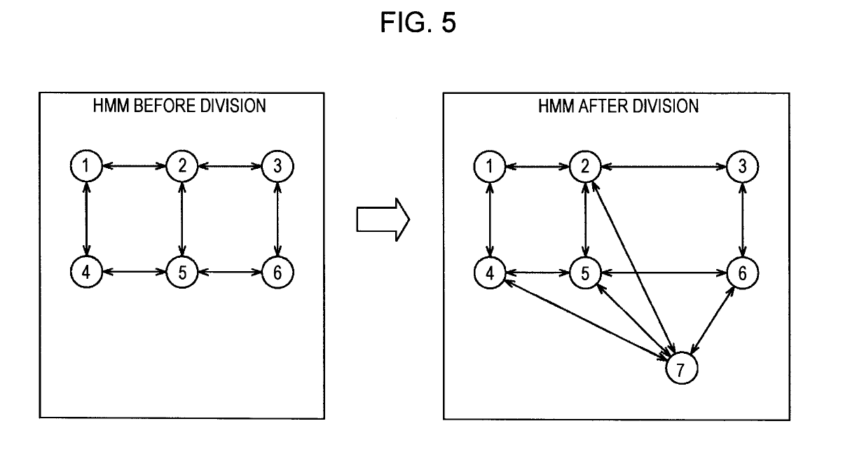

FIG. 5 is a diagram illustrating the division of a state as the structure adjustment performed by the structure adjustment unit 16.

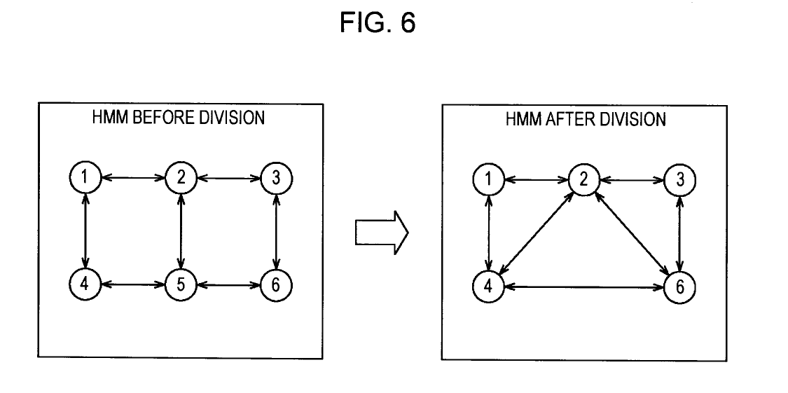

Here, in FIG. 5 (the same is true of FIG. 6 described later), the circle denotes a state of the HMM, and the arrow denotes a state transition. In addition, in FIG. 5, the bidirectional arrow connecting two states to each other denotes a state transition from one state to the other state of the two states, and a state transition from the other state to the one state. Further, in FIG. 5, each state can perform a self transition, and an arrow denoting the self transition is not shown in the figure.

Also, in the figure, the number i inside the circle denoting a state is an index for discriminating states, and, hereinafter, a state with the number i as an index is denoted by a state sᵢ.

In FIG. 5, an HMM before the state division is performed (HMM before division) has six states sᵢ, s₂, s₃, s₄, s₅ and s₆ where bidirectional state transitions between the states s₁ and s₂, between the states s₁ and s₄, between the states s₂ and s₃, between the states s₂ and s₅ between the states s₃ and s₆ between the states s₄ and s₅, and between the s₅ and the s₆, and self transitions are respectively possible.

Now, if, for example, the state s₅ is selected as a division target among the states s₁ to s₆ of the HMM before division, the structure adjustment unit 16 adds a new state s₇ to the HMM in the state division targeting the state s₅ as the division target.

In addition, the structure adjustment unit 16 adds respective state transitions between the state s₇ and the states s₂, s₄ and s₆ having the state transitions with the state s₅ which is the division target, a self transition, and a state transition between the state s₇ and the state s₅ which is the division target, as state transitions (of which the state transition probability is not 0.0) with the new state s₇.

As a result, in the state division, the state s₅ which is the division target is divided into the state s₅ and the new state s₇, and further, according to the addition of the new state s₇, the state transitions with the new state s₇ are added.

In addition, in the state division, with respect to the HMM after the state division is performed (HMM after division), parameters of the HMM are adjusted according to the addition of the new state s₇ and the addition of the state transitions with the new state s₇.

In other words, the structure adjustment unit 16 sets an initial probability π₇ and a probability distribution b₇(o) of the state s₇, and sets predetermined values as state transition probabilities a₇ⱼ and aᵢ₇ of the state transitions with the state s₇.

Specifically, for example, the structure adjustment unit 16 sets half of the initial probability π₅ of the state s₅ which is the division target as the initial probability π₇ of the state s₇, and, accordingly, sets the initial probability π₅ of the state s₅ which is the division target to half of the current value.

In addition, the structure adjustment unit 16 sets (gives) the probability distribution b₅(o) of the state s₅ which is the division target as the probability distribution b₇(o) of the state s₇.

Further, the structure adjustment unit 16 sets half of the state transition probabilities a₅ⱼ and aᵢ₅ of the state transitions between the state s₅ which is the division target and each of the states s₂, s₄ and s₆ as the state transition probabilities a₇ⱼ and aᵢ₇ of the state transitions with the states s₂, s₄ and s₆ other than the state s₅ which is the division target of the state transitions with the state s₇ (a₇₂=a₅₂/2, a₇₄=a₅₄/2, a₇₆=a₅₆/2, a₂₇=a₂₅/2, a₄₇=a₄₅/2, and a₆₇=a₆₅/2).

The structure adjustment unit 16 sets the state transition probabilities a₅ⱼ and aᵢ₅ of the state transitions between the state s₅ which is the division target and each of the states s₂, s₄ and s₆ to half of the current values when the state transition probabilities a₇ⱼ and aᵢ₁ of the state transitions between the state s₇ and the states s₂, s₄ and s₆ other than the state s₅ which is the division target, are set.

In addition, the structure adjustment unit 16 sets half of the state transition probability a₅₅ of the self transition of the state s₅ which is the division target as the state transition probabilities a₅₇ and a₇₅ of a state transition between the state s₇ and the state s₅ which is the division target, and the state transition probability a₇₇ of the self transition of the state s₇, and, thereby, sets the state transition probability a₅₅ of the self transition of the state s₅ which is the division target to half of the current value.

Thereafter, the structure adjustment unit 16 normalizes parameters necessary for the HMM after the state division and finishes the state division.

In other words, the structure adjustment unit 16 normalizes the state transition probability aᵢⱼ such that the state transition probability aᵢⱼ of the HMM after the state division satisfies the equation Σaᵢⱼ=1 (where i=1, 2, . . . , N).

Here, E in the equation Σaᵢⱼ=1 denotes summation when the variable j indicating a state changes from 1 to the number N of states of the HMM after the state division. In FIG. 5, the number N of states of the HMM after the state division is 7.

In the normalization process for the state transition probability aᵢⱼ, the state transition probability aᵢⱼ after the normalization is obtained by dividing the state transition probability aᵢⱼ before the normalization by the sum total of aᵢ₁+aᵢ₂+ . . . +a_{iN} regarding a state sⱼ which is the transition destination of the state transition probability aᵢⱼ before the normalization.

Also, in FIG. 5, the state division is performed by targeting one state s₅ as the division target, but the state division may be performed by targeting a plurality of states as division targets, and may be performed in parallel for the plurality of division targets.

If the state division is performed by targeting M states of one or more as division targets, an HMM after division further increases by M states than an HMM before division.

Here, in FIG. 5, the parameters (the initial probability π₇, the state transition probabilities a₇ⱼ and aᵢ₇, and the probability distribution b₇(o)) for the HMM related to the new state s₇ which is divided from the state s₅ which is the division target are set based on the parameters of the HMM related to the state s₅ which is the division target, but, in addition, as parameters of an HMM related to the new state s₇, fixed parameters of new states may be prepared in advance, and the fixed parameters may be set.

### Mergence of State

FIG. 6 is a diagram illustrating the mergence of a state as the structure adjustment performed by the structure adjustment unit 16.

In FIG. 6, in the same manner as the HMM before division in FIG. 5, an HMM before the state mergence is performed (HMM before mergence) has six states s₁, s₂, s₃, s₄, s₅, and s₆, where bidirectional state transitions between the states s₁ and s₂, between the states s₁ and s₄, between the states s₂ and s₃, between the states s₂ and s₅, between the states s₃ and s₆, between the states s₄ and s₅, and between the s₅ and the s₆, and self transitions are respectively possible.

Now, if, for example, the state s₅ is selected as a mergence target among the states s₁ to s₆ of the HMM before mergence, the structure adjustment unit 16 removes the state s₅ which is the mergence target in the state mergence targeting the state s₅ as the mergence target.

In addition, the structure adjustment unit 16 adds state transitions among the other states (hereinafter, also referred to as merged states) s₂, s₄ and s₆ which have the state transitions (of which the state transition probability is not 0.0) with the state s₅ which is the mergence state, that is, between the states s₂ and s₄, between the states s₂ and s₆, and between the states s₄ and s₆.

As a result, in the state mergence, the state s₅ which is the mergence target is merged into each of the other states (merged state) s₂, s₄ and s₆ which have the state transitions with the state s₅, and the state transitions with the state s₅ are merged into (handed over to) the state transitions with other states s₂, s₄ and s₆ in a form of having the state s₅ as a bypass.

In addition, in the state mergence, with respect to the HMM after the state mergence is performed (HMM after mergence), parameters of the HMM are adjusted according to the removal of the state s₅ which is the mergence target and mergence of the state transitions with the state s₅ (the addition of the state transitions between the merged states).

That is to say, the structure adjustment unit 16 sets a predetermined value as the state transition probability aᵢⱼ of the state transitions between each of the merged states s₂, s₄ and s₆.

Specifically, for example, the structure adjustment unit 16 sets a value obtained by multiplying the state transition probability aᵢ₅ (of the state transition) from the merged state sᵢ to the state s₅ which is the mergence target by the state transition probability aᵢⱼ (of the state transition) from the state s₅ which is the mergence target to the merged state sⱼ (aᵢⱼ=aᵢ₅×a₅ⱼ) as the state transition probability a₅ⱼ (of the state transition) from an arbitrary merged state sᵢ to another merged state sⱼ.

In addition, the structure adjustment unit 16 equally distributes the initial probability π₅ of the state s₅ which is the mergence target to each of the merged states s₂, s₄ and s₆, or all of the states s₁, s₂, s₃, s₄ and s₆ of the HMM after mergence.

In other words, if the number of the state sᵢ to which the initial probability π₅ of the state s₅ which is the mergence target is equally distributed is K, the initial probability πᵢ the state sᵢ is set to a sum of a current value and a 1/K of the initial probability π₅ of the state s₅ which is the mergence target.

Thereafter, the structure adjustment unit 16 normalizes parameters necessary for the HMM after the state mergence and finishes the state mergence.

In other words, in the same manner as the state division, the structure adjustment unit 16 normalizes the state transition probability aᵢⱼ such that the state transition probability of the HMM after the state mergence satisfies the equation Σaᵢⱼ=1 (where i=1, 2, . . . , N).

Also, in FIG. 6, the state mergence is performed by targeting one state s₅ as the mergence target, but the state mergence may be performed by targeting a plurality of states as mergence targets, and may be performed in parallel for the plurality of mergence targets.

If the state mergence is performed by targeting M states of one or more as mergence targets, an HMM after mergence further decreases by M states than an HMM before mergence.

Here, in FIG. 6, the state transition probability between each of the merged states is set based on the state transition probability between the state s₅ which is the mergence target and each of the merged states, but, in addition, as a state transition probability between each of the merged states, a fixed state transition probability for mergence may be prepared in advance, and the fixed state transition probability may be set.

In addition, in FIG. 6, the initial probability π₅ of the state s₅ which is the mergence target is equally distributed to the merged states s₂, s₄ and s₆ or all the states s₁, s₂, s₃, s₄ and s₆ of the HMM after mergence, but the initial probability π₅ of the state s₅ which is the mergence target may not be equally distributed.

However, if the initial probability π₅ of the state s₅ which is the mergence target is not equally distributed, it is necessary to normalize the initial probability πᵢ such that the initial probability πᵢ of an HMM after the state mergence satisfies the equation Σπᵢ=1.

Here, Σ in the equation Σπᵢ=1 denotes summation when the variable i indicating a state changes from 1 to the number N of states of the HMM after the state division. In FIG. 6, the number N of states of the HMM after the state division is 5.

In the normalization process for the initial probability πᵢ, the initial probability πᵢ after the normalization is obtained by dividing the initial probability πᵢ before the normalization by the sum total of πᵢ+π₂+ . . . +π_{N} of the initial probability πᵢ before the normalization.

### Selection Method of Division Target and Mergence Target

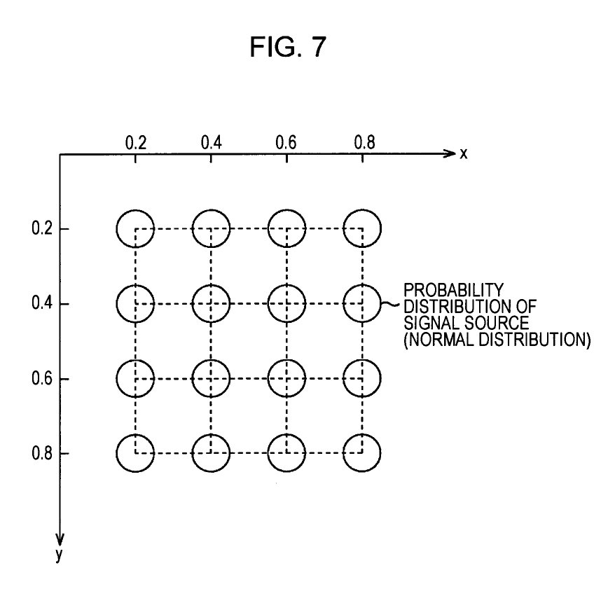

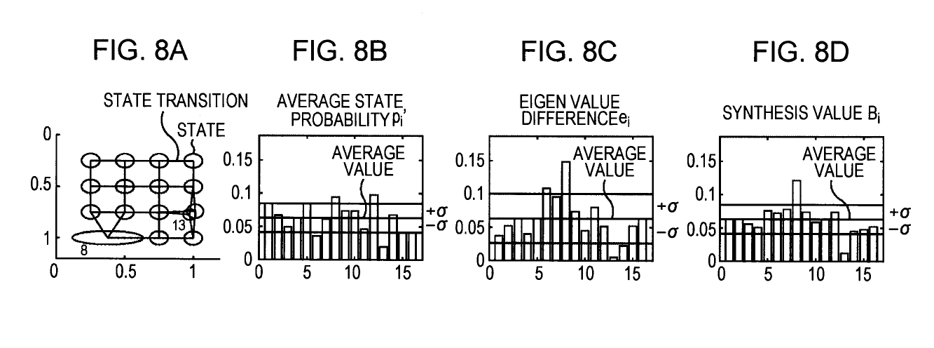

FIGS. 7 and 8 are diagrams illustrating a selection method for selecting a division target and a mergence target in a case where a state is divided and merged in the structure adjustment unit 16.

In other words, FIG. 7 is a diagram illustrating observed time series data as learning data used to learn an HMM for which simulation is performed by the present applicant in order to select a division target and a mergence target.

In the simulation, a signal source which appears at an arbitrary position on a two-dimensional space (plane) and outputs coordinates of the position is targeted as a modeling target, and the coordinate output by the signal source is used as an observed value o.

In addition, the signal source appears along sixteen normal distributions which have an average value of (coordinates) of each of sixteen points which are obtained by equally dividing a range from 0.2 to 0.8 at an interval of 0.2 in the x coordinate and equally dividing a range from 0.2 to 0.8 at an interval of 0.2 in the y coordinate on the two-dimensional space, and which have 0.00125 as a variance.

Here, in FIG. 7, the sixteen circles denote probability distribution of a signal source (a position thereof) appearing along the normal distributions as described above. In other words, the center of the circle indicates an average value of the position (coordinates thereof) where the signal source appears, and the diameter of the circle indicates a variance of a position where the signal source appears.

A signal source randomly selects one normal distribution from the sixteen normal distributions and appears along the normal distribution. Further, the signal source outputs coordinates of the position where it appears, and selects a normal distribution again.

In addition, the signal source repeats the process until each of the sixteen normal distributions is selected a sufficient predetermined number of times or more, and thereby time series of coordinates as an observed value o is observed from the outside.

In addition, in the simulation in FIG. 7, the selection of a normal distribution is limited so as to be performed from normal distributions transversely adjacent and normal distributions longitudinally adjacent to a previously selected normal distribution.

In other words, normal distributions transversely and longitudinally adjacent to a previously selected normal distribution are referred to as adjacent normal distributions, and if a total number of the adjacent normal distributions is C, the adjacent normal distributions are all selected with the probability of 0.2, and the previously selected normal distribution is selected with the probability of 1-0.2C.

In FIG. 7, the dotted lines connecting the circles denoting the normal distributions to each other indicates the limitation in the selection of normal distributions in the simulation.

The learning for an HMM which uses the time series of coordinates as an observed value o observed from the signal source as learning data, employs the normal distributions as the probability distribution bⱼ(o) of the state sⱼ, and has sixteen states, is carried out, and, if the HMM after being learned is configured in the same manner as the probability distribution of the signal source, it can be said that the HMM appropriately represents the modeling target.

In other words, each state of the HMM after being learned is expressed on the two-dimensional space using the circle which has as the center the average value (the position indicated by it) of the normal distribution which is the probability distribution bⱼ(o) of the sⱼ of the HMM after being learned and which has as the diameter the variance of the normal distribution, and the state transitions of the state transition probability equal to or more than a predetermined value between states, denoted by the circles, are denoted by the dotted lines. In this case, like in FIG. 7, if the sixteen circles can be drawn and the dotted lines connecting the transversely and longitudinally adjacent circles to each other can be drawn, it can be said that the HMM after being learned appropriately represents the modeling target.

FIGS. 8A to 8D are diagrams illustrating results of the simulation for selecting a division target and a mergence target.

In the simulation, the learning for the HMM (estimation of parameters of the HMM using the Baum-Welch algorithm) is performed using the observed time series data observed from the signal source (the time series of coordinates for the signal source) in FIG. 7 as learning data.

As the HMM, for example, an ergodic HMM having sixteen states s₁ to s₁₆ is used, and a normal distribution is used as the probability distribution bⱼ(o) of the state sⱼ.

FIG. 8A shows the HMM after being learned.

In FIG. 8A, the circles (circles or ellipses) shown on the two-dimensional space indicate the state sⱼ of the HMM after being learned.

In addition, in FIG. 8A, the center of the circle denoting the state sⱼ is the same as an average value of the normal distribution which is the probability distribution bⱼ(o) of the state sⱼ, and the diameter of the circle corresponds to the variance of the normal distribution which is the probability distribution bⱼ(o).

Further, in FIG. 8A, the line segment connecting the circles denoting the states to each other indicates a state transition (of a state transition probability equal to or more than a predetermined value).

According to FIG. 8A, it can be seen that it is possible to obtain an HMM which appropriately represents a signal source by dividing the state s₈ and merging the state s₁₃, that is, it can be seen that the state s₈ is divided and the state s₁₃ is merged in order to obtain the HMM appropriately representing the signal source.

FIG. 8B shows an average state probability of each of the states s₁ to s₁₆ of the HMM after being learned in FIG. 8A.

In addition, in FIG. 8B (the same is true of FIGS. 8C and 8D described later), the transverse axis indicates a state sᵢ (an index i thereof) of the HMM after being learned.

Here, if a certain state sᵢ is noted, an average state probability pᵢ′ of the noted state sᵢ is a value obtained by averaging state probability of the noted state sᵢ when a sample (observed value o) of the observed time series data (here, learning data) at each time is observed, in a time direction.

In other words, in the HMM after being learned, a forward probability of the state sᵢ (=Sₜ) at each time t when the learning data o=o₁, o₂, . . . , o_{T} is observed is indicated by pᵢ(t)=p(o₁, o₂, . . . , o_{T}, Sₜ).

Here, the forward probability pᵢ(t)=p(o₁, o₂, . . . , oₜ, Sₜ) is the probability of the state Sₜ (=s₁, s₂, . . . , s_{N}) at time t when the time series o₁, o₂, . . . , oₜ of the observed value is observed, and can be obtained by a so-called forward algorithm.

The average state probability pᵢ′ of the noted state sᵢ can be obtained by the equation pᵢ′=(pᵢ(1)+pᵢ(2)+ . . . +pᵢ(T))/T.

According to FIG. 8B, it can be seen that the average state probability p₈′ of the state s₈ to be divided in order to obtain an HMM appropriately representing the signal source is much greater than the average value of the average state probabilities p₁′ to p₁₆′ of all the respective states s₁ to s₁₆ of the HMM (after being learned), and the average state probability p₁₃′ of the state s₁₃ to be merged in order to obtain an HMM appropriately representing the signal source is much smaller than the average value of the average state probabilities p₁′ to p₁₆′ of all the respective states s₁ to s₁₆ of the HMM.

FIG. 8C shows an eigen value difference for each of the states s₁ to s₁₆ of the HMM in FIG. 8A.

Here, the eigen value difference eᵢ of the noted state sᵢ is a difference eᵢ^{part}−e^{org} between a partial eigen value sum eᵢ^{part} of the noted state sᵢ and a total eigen value sum e^{org} of the HMM.

The total eigen value sum e^{org} of the HMM is a sum (sum total) of eigen values of a state transition matrix which has the state transition probability aᵢⱼ from each state sᵢ to each state sⱼ of the HMM as components. If the number of states of the HMM is N, the state transition matrix becomes a square matrix of N rows and N columns.

In addition, the sum of the eigen values of the square matrix can be obtained by picking a sum of eigen values after the eigen values of the square matrix are calculated or by calculating a sum (sum total) of diagonal components (trace) of the square matrix. The calculation for the trace of the square matrix is much smaller than the calculation for the eigen values of the square matrix in a calculation amount, and thus, it is preferable that a sum of the eigen values of the square matrix is obtained by calculating the trace of the square matrix on board.

The partial eigen value sum eᵢ^{part} of the noted state sᵢ is a sum of eigen values of a square matrix (hereinafter, also referred to as a partial state transition matrix) of (N−1) rows and (N−1) columns excluding the state transition probability aᵢⱼ (where j=1, 2, . . . , N) from the noted state sᵢ and the state transition probability aⱼᵢ (where j=1, 2, . . . , N) to the noted state sⱼ from the state transition matrix.

Since the state transition matrix (the same is true of the partial state transition matrix) has a probability (state transition probability) as a component, the eigen value thereof is a value equal to or less than 1 which is the maximum value which can be selected as a probability.

Further, according to knowledge of the present inventor, the greater the eigen value of the state transition matrix is, the faster the probability distribution bᵢ(o) of each state of the HMM converges.

Therefore, the eigen value difference eᵢ (eᵢ^{part}−e^{org}) of the noted state sᵢ which is a difference between the partial eigen value sum eᵢ^{part} of the noted state sᵢ and the total eigen value sum e^{org} of the HMM may indicate a difference in convergence of the probability distribution bᵢ(o) between an HMM where the noted state sᵢ exists and an HMM where the noted state sᵢ does not exist.

According to FIG. 8C, it can be seen that the eigen value difference e₈ of the state s₈ to be divided in order to obtain an HMM appropriately representing the signal source is much greater than an average value of the eigen value differences e₁ to e₁₆ of the respective states s₁ to s₁₆ of the HMM, and the eigen value difference e₁₃ of the state s₁₃ to be merged in order to obtain an HMM appropriately representing the signal source is much smaller than an average value of the eigen value differences e₁ to e₁₆ of the respective states s₁ to s₁₆ of the HMM.

FIG. 8D shows the respective synthesis values of the states s₁ to s₁₆ of the HMM in FIG. 8A.

The synthesis value Bᵢ of the noted state sᵢ is a value obtained by synthesizing the average state probability pᵢ′ of the noted state sᵢ with the eigen value difference eᵢ, and, for example, may use a weighted sum value of the average state probability pᵢ′ and a normalized eigen value difference eᵢ′ obtained by normalizing the eigen value eᵢ.

In a case where the weighted sum value of the average state probability pᵢ′ and the normalized eigen value difference eᵢ′ is used as the synthesis value Bᵢ of the noted state sᵢ, if a weight is α (where 0≦α≦1), the synthesis value Bᵢ can be obtained by the equation Bᵢ=αpᵢ′+(1−α)eᵢ′.

In addition, the normalized eigen value difference eᵢ′ can be obtained by, for example, normalizing the eigen value difference eᵢ such that the sum total of the normalized eigen value difference eᵢ′ e₁′+e₂′+ . . . +e_{N}′ of all the states of the HMM, that is, by the equation eᵢ′=eᵢ/(e₁+e₂+ . . . +e_{N}).

Here, the synthesis value Bᵢ may be a value corresponding to the average state probability pᵢ′ or the eigen value difference eᵢ since it is obtained by synthesizing the average state probability pᵢ′ with the eigen value difference eᵢ such as synthesizing the average state probability pᵢ′ with (the normalized eigen value difference eᵢ′ obtained by normalizing) the eigen value difference eᵢ.

According to FIG. 8D, it can be seen that the synthesis value B₈ of the state s₈, to be divided in order to obtain an HMM appropriately representing the signal source is much greater than an average value of the eigen value differences e₁ to e₁₆ of the respective states s₁ to s₁₆ of the HMM, and the synthesis value B₁₃ of the state s₁₃ to be merged in order to obtain an HMM appropriately representing the signal source is much smaller than an average value of the eigen value differences e₁ to e₁₆ of the respective states s₁ to s₁₆ of the HMM.

From the simulation in FIGS. 7 to 8D, as target degree values indicating a degree of propriety for selecting a state as a division target or a mergence target, the average state probability pᵢ′, the eigen value difference eᵢ, and the synthesis value Bᵢ may be used, and, by selecting the division target and the mergence target based on the target degree value, a state to be divided and a state to be merged in order to obtain an HMM appropriately representing a signal source may be selected.

In other words, in FIG. 8A, although the state s₈ is divided in order to obtain an HMM appropriately representing a signal source, the target degree values (the average state probability p₈′, the eigen value difference e₈, and the synthesis value B₈) of the state s₈ to be divided are much greater than the average value of the target degree values of all the states of the HMM.

In addition, in FIG. 8A, although the state s₁₃ is merged in order to obtain an HMM appropriately representing a signal source, the target degree values (the average state probability p₁₃′, the eigen value difference e₁₃, and the synthesis value B₁₃) of the state s₁₃ to be merged are much smaller than the average value of the target degree values of all the states of the HMM.

Therefore, conversely speaking, if a state having target degree values much greater than an average value of target degree values exists, the state is selected as a division target, and it is possible to obtain an HMM appropriately representing a signal source by dividing the state.

In addition, if a state having target degree values much smaller than an average value of target degree values exists, the state is selected as a mergence target, and it is possible to obtain an HMM appropriately representing a signal source by merging the state.

Therefore, the structure adjustment unit 16 sets a value greater than an average value of target degree values of all the states of an HMM stored in the model storage unit 14 as a division threshold value which is a threshold value for selecting a division target and sets a value smaller than the average value as a mergence threshold value which is a threshold value for selecting a mergence target.

In addition, the structure adjustment unit 16 selects a state having target degree values larger than the division threshold value (equal to or larger than the division threshold value) as a division target and selects a state having target degree values smaller than a mergence threshold value (equal to or smaller than the mergence threshold value) as a mergence target.

Here, as the division threshold value, a value obtained by adding a predetermined positive value to an average value (hereinafter, also referred to as a target degree average value) of target degree values of all the states of the HMM stored in the model storage unit 14 may be used, and, as the mergence threshold value, a value obtained by subtracting a predetermined positive value from the target degree average value may be used.

As the predetermined positive value, for example, a fixed value empirically obtained from simulations, a standard deviation σ (or a value proportional to the standard deviation σ) of target degree values of all the states of the HMM stored in the model storage unit 14, or the like may be used.

In this embodiment, as the predetermined positive value, for example, the standard deviation σ of the target degree values of all the states of the HMM stored in the model storage unit 14 is used.

In addition, as the target degree values, any one of the average state probability pᵢ′, the eigen value difference eᵢ, and the synthesis value Bᵢ may be used.

In addition, since the eigen value difference eᵢ is an eigen value difference eᵢ itself, and the synthesis value Bᵢ is a value obtained by the synthesis using the eigen value difference eᵢ, both of them may be values corresponding to the eigen value difference eᵢ.

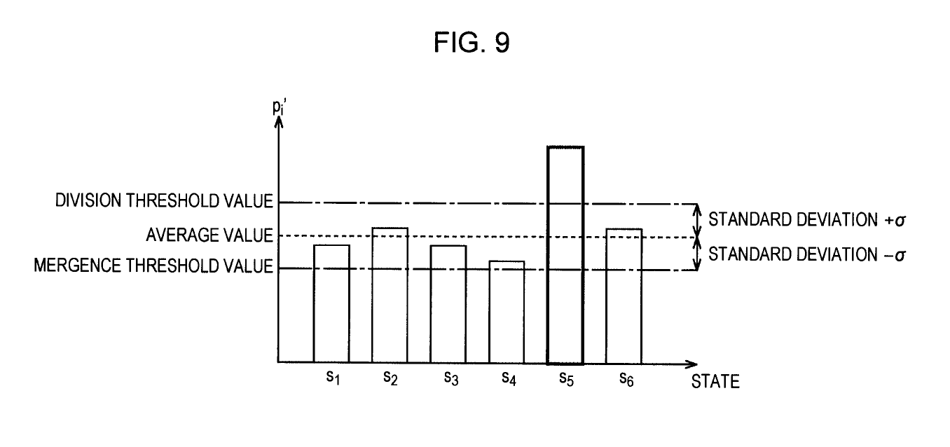

FIG. 9 is a diagram illustrating selection of a division target and a mergence target, which is performed using the average state probability pᵢ′ as the target degree value.

In other words, FIG. 9 shows the average state probability pᵢ′ as a target degree value of each state sᵢ of an HMM having six states s₁ to s₆.

In FIG. 9, of the six states s₁ to s₆, the average state probability p₅′ of the state s₅ is larger than a division threshold value which is obtained by adding the standard deviation σ of the target degree values of all the states s₁ to s₆ to an average value (hereinafter, referred to as a target degree average value) of the target degree values of all the six states s₁ to s₆.

In addition, in FIG. 9, of the six states s₁ to s₆, the average state probabilities of the five states s₁ to s₄ and s₆ excluding the state s₅, are not larger than the division threshold value and are not smaller than the mergence threshold value obtained by subtracting the standard deviation σ from the target degree average value.

For this reason, in FIG. 9, only the state s₅ having the average state probability larger than the division threshold value is selected as a division target.

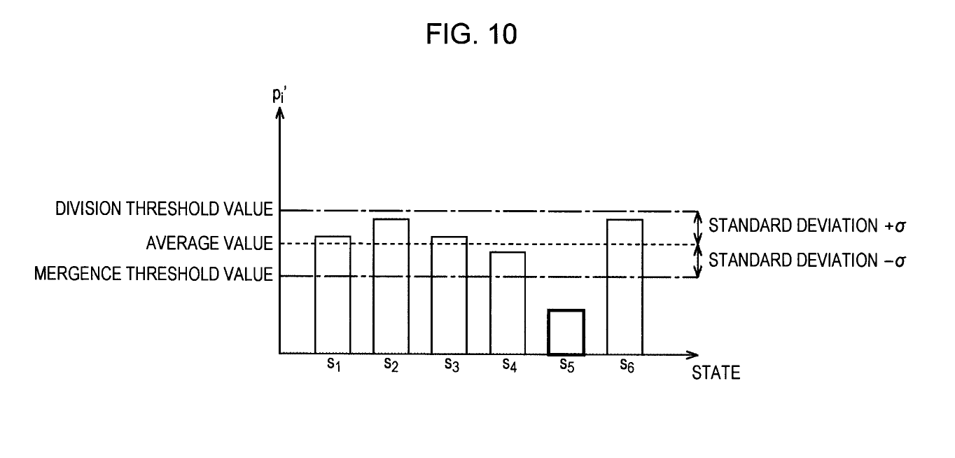

FIG. 10 is a diagram illustrating selection of a division target and a mergence target, which is performed using the average state probability pᵢ′ as the target degree value.

In other words, FIG. 10 shows the average state probability pᵢ′ as a target degree value of each state sᵢ of an HMM having six states s₁ to s₆.

In FIG. 10, of the six states s₁ to s₆, the average state probability p₅′ of the state s₅ is smaller than the mergence threshold value.

In addition, in FIG. 10, of the six states s₁ to s₆, the average state probabilities of the five states s₁ to s₄ and s₆ excluding the state s₅, are not larger than the division threshold value and are not smaller than the mergence threshold value obtained by subtracting the standard deviation σ from the target degree average value.

For this reason, in FIG. 10, only the state s₅ having the average state probability smaller than the mergence threshold value is selected as a mergence target.

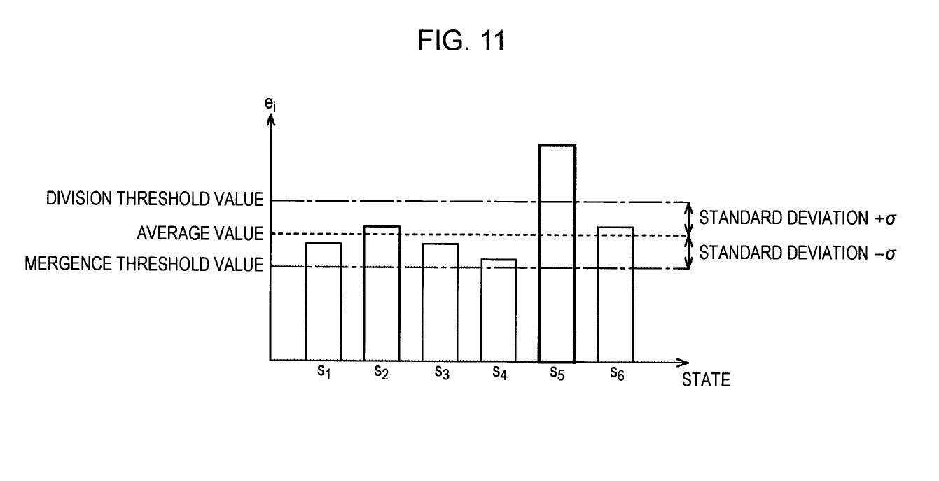

FIG. 11 is a diagram illustrating selection of a division target and a mergence target, which is performed using the eigen value difference eᵢ as the target degree value.

In other words, FIG. 11 shows the eigen value difference eᵢ as a target degree value of each state sᵢ of an HMM having six states s₁ to s₆.

In FIG. 11, of the six states s₁ to s₆, the eigen value difference e₅ of the state s₅ is larger than the division threshold value.

In addition, in FIG. 11, of the six states s₁ to s₆, the eigen value differences of the five states s₁ to s₄ and s₆ excluding the state s₅, are not larger than the division threshold value and are not smaller than the mergence threshold value.

For this reason, in FIG. 11, only the state s₅ having the eigen value difference larger than the division threshold value is selected as a division target.

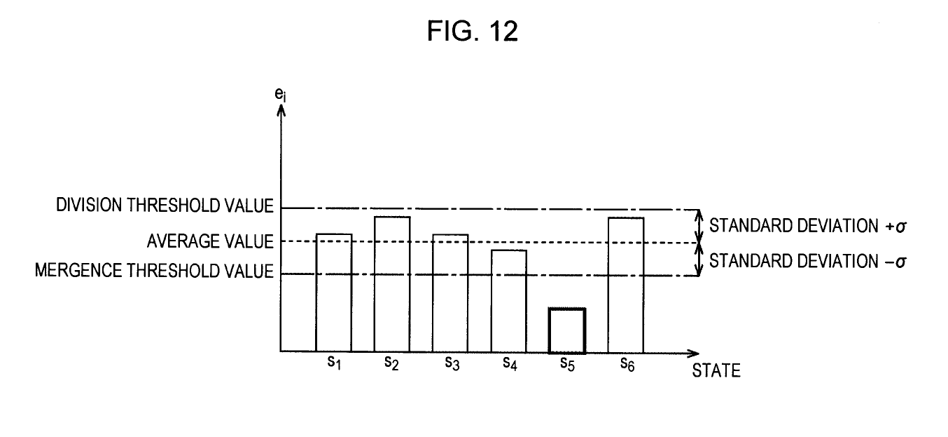

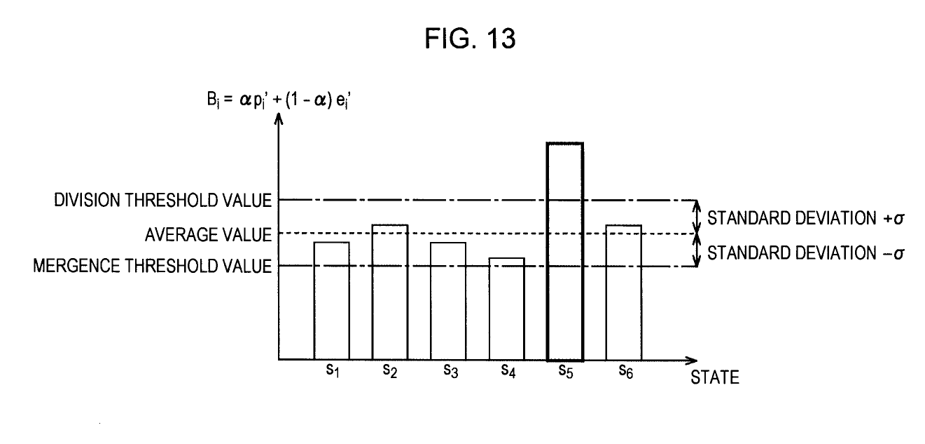

FIG. 12 is a diagram illustrating selection of a division target and a mergence target, which is performed using the eigen value difference eᵢ as the target degree value.

In other words, FIG. 12 shows the eigen value difference eᵢ as a target degree value of each state sᵢ of an HMM having six states s₁ to s₆.

In FIG. 12, of the six states s₁ to s₆, the eigen value difference e₅ of the state s₅ is smaller than the mergence threshold value.

In addition, in FIG. 12, of the six states s₁ to s₆, the eigen value differences of the five states s₁ to s₄ and s₆ excluding the state s₅, are not larger than the division threshold value and are not smaller than the mergence threshold value.

For this reason, in FIG. 12, only the state s₅ having the eigen value difference smaller than the mergence threshold value is selected as a mergence target.

FIG. 13 is a diagram illustrating selection of a division target and a mergence target, which is performed using the synthesis value Bᵢ as the target degree value.

In other words, FIG. 13 shows the synthesis value Bᵢ as a target degree value of each state sᵢ of an HMM having six states s₁ to s₆.

In FIG. 13, of the six states s₁ to s₆, the synthesis value B₅ of the state s₅ is larger than the division threshold value.

In addition, in FIG. 13, of the six states s₁ to s₆, the synthesis values of the five states s₁ to s₄ and s₆ excluding the state s₅, are not larger than the division threshold value and are not smaller than the mergence threshold value.

For this reason, in FIG. 13, only the state s₅ having the synthesis value larger than the division threshold value is selected as a division target.

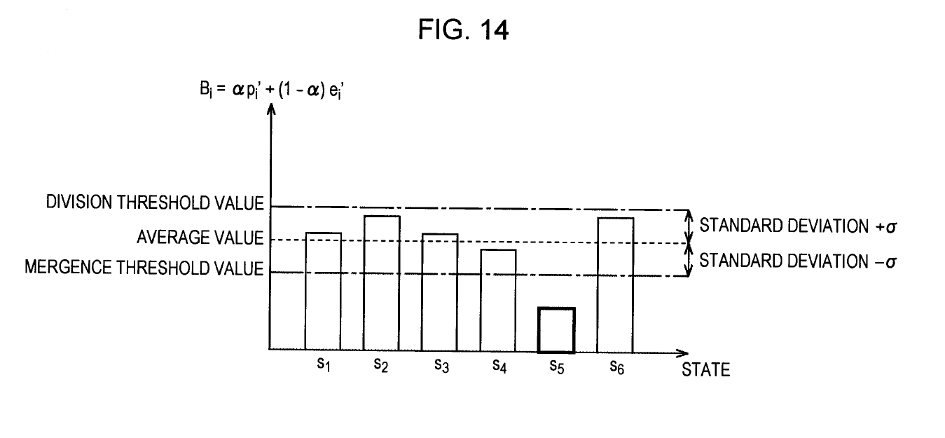

FIG. 14 is a diagram illustrating selection of a division target and a mergence target, which is performed using the synthesis value Bₗ as the target degree value.

In other words, FIG. 14 shows the synthesis value Bᵢ as a target degree value of each state sᵢ of an HMM having six states s₁ to s₆.

In FIG. 14, of the six states s₁ to s₆, the synthesis value B₅ of the state s₅ is smaller than the mergence threshold value.

In addition, in FIG. 14, of the six states s₁ to s₆, the synthesis values of the five states s₁ to s₄ and s₆ excluding the state s₅, are not larger than the division threshold value and are not smaller than the mergence threshold value.

For this reason, in FIG. 14, only the state s₅ having the synthesis value smaller than the mergence threshold value is selected as a mergence target.

### Learning Process for HMM in Data Processing Device

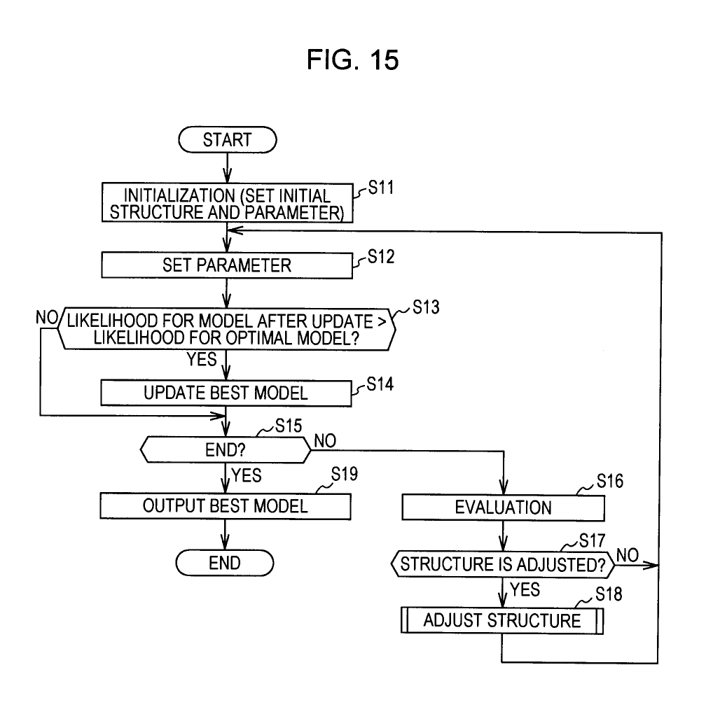

Next, FIG. 15 is a flowchart illustrating a learning process for an HMM performed by the data processing device in FIG. 4.

If the time series data input unit 11 is supplied with a sensor signal from a modeling target, the time series data input unit 11, for example, normalizes the sensor signal observed from the modeling target and supplies the normalized sensor signal to the parameter estimation unit 12 as observed time series data o.

If the observed time series data o is supplied from the time series data input unit 11, the parameter estimation unit 12 initializes an HMM in step S11.

In other words, the parameter estimation unit 12 initializes a structure of the HMM to a predetermined initial structure, and sets parameters (initial parameters) of the HMM with the initial structure.

Specifically, the parameter estimation unit 12 sets the number of states and state transitions (of which the state transition probability is not 0) of the HMM, as an initial structure of the HMM.

Here, the initial structure of the HMM (the number of states and state transitions of the HMM) may be set in advance.

The HMM with the initial structure may be an HMM with a sparse structure in which state transitions are sparse, or may be an ergodic HMM. In addition, if the HMM with the sparse structure is employed as an HMM with an initial structure, each state can perform a self transition and a state transition between it and at least one of other states.

If setting the initial structure of the HMM, the parameter estimation unit 12 sets initial values of the state transition probability aᵢⱼ, the probability distribution bⱼ(o), and the initial probability πᵢ as initial parameters, to the HMM with the initial structure.

In other words, the parameter estimation unit 12 sets the state transition probability aᵢⱼ of a state transition which is possible from a state to the same value (if the number of state transitions possible is L, 1/L) and sets the state transition probability aᵢⱼ of a state transition which is not possible to 0, for each state.

In addition, if, for example, a normal distribution is used as the probability distribution bⱼ(o), the parameter estimation unit 12 obtains a mean value μ and a variance σ² of the observed time series data o=o₁, o₂, . . . , o_{T} from the time series data input unit 11 by the following equation, and sets a normal distribution defined by the mean value μ and the variance σ² to the probability density function bⱼ(o) indicating the probability distribution bⱼ(o) of each state sⱼ.

μ=(1/T)Σoₜ σ²=(1/T)Σ(oₜ−μ)²

Here, in the above equation, Σ indicates summation (sum total) when the time t changes from 1 to T which is the length of the observed time series data o.

In addition, the parameter estimation unit 12 sets the initial probability πᵢ of each state sᵢ to the same value. In other words, if the number of states of the HMM with the initial structure is N, the parameter estimation unit 12 sets the initial probability πᵢ of each of the N states sᵢ to 1/N.

In the parameter estimation unit 12, the HMM of which the initial structure and the initial parameters λ={aᵢⱼ, bⱼ(o), πᵢ, i=1, 2, . . . , N, j=1, 2, . . . , N} are set is supplied to and stored in the model storage unit 14. The (initial) structure of and the (initial) parameters λ for the HMM stored in the model storage unit 14 are updated by the parameter estimation and the structure adjustment which are subsequently performed.

In other words, in step S11, the HMM of which the initial structure and the initial parameters λ are set is stored in the model storage unit 14, and then the process goes to step S12, where the parameter estimation unit 12 estimates new parameters of the HMM by the Baum-Welch algorithm, using the parameters of the HMM stored in the model storage unit 14 as initial values and using the observed time series data o from the time series data input unit 11 as learning data used to learn the HMM.

In addition, the parameter estimation unit 12 supplies the new parameters of the HMM to the model storage unit 14 and updates the HMM (parameters therefor) stored in the model storage unit 14 in an overwriting manner.

In addition, the parameter estimation unit 12 increases the number of learnings which is reset to 0 at the time of starting of the learning in FIG. 15 by 1, and supplies the number of learnings to the evaluation unit 13.

In addition, the parameter estimation unit 12 obtains a likelihood in which the learning data o is observed from the HMM after being updated, that is, the HMM defined by the new parameters, and supplies the likelihood to the evaluation unit 13 and the structure adjustment unit 16. Then, the process goes to step S13 from step S12.

In step S13, the structure adjustment unit 16 determines whether or not the likelihood (likelihood in which the learning data o is observed from the HMM after being updated) for the HMM after being updated from the parameter estimation unit 12 is larger than the likelihood for the HMM as the best model stored in the model buffer 15.

In step S13, if it is determined that the likelihood for the HMM after being updated is larger than the likelihood for the HMM as the best model stored in the model buffer 15, the process goes to step S14, where the structure adjustment unit 16 stores the HMM (parameters therefor) after being updated stored in the model storage unit 14 in the model buffer 15 as a new best model in an overwriting manner, thereby, updating the best model stored in the model buffer 15.

In addition, the structure adjustment unit 16 stores the likelihood for the HMM after being updated from the parameter estimation unit 12, that is, the likelihood for the new best model in the model buffer 15, and the process goes to step S15 from step S14.

In addition, after the initialization in step S11, if the process in step S13 is performed for the first time, a best mode (and likelihood) is not stored in the model buffer 15, but the likelihood for the HMM after being updated is determined as being larger than the likelihood for the HMM as the best mode in step S13, and, in step S14, the HMM after being updated is stored in the model buffer 15 as a best model along with the likelihood for the HMM after being updated.

In step S15, the evaluation unit 13 determines whether or not the learning for the HMM is finished.

Here, the evaluation unit 13 determines that the learning for the HMM is finished, for example, in a case where the number of learnings supplied from the parameter estimation unit 12 reaches a predetermined number C1 set in advance.

In addition, for example, if the number of parameter estimations after the near structure adjustment is performed (a value obtained by subtracting the number of learnings when near structure adjustment is performed from the current number of learnings) reaches a predetermined number C2 (<C1) set in advance, that is, the parameter estimations are performed only by the predetermined number C2 without performing the structure adjustment, the evaluation unit 13 determines that the learning for the HMM is finished.

In addition, the evaluation unit 13 may determine whether or not the learning for the HMM is finished based on a result of a structure adjustment process in step S18 described later, which is previously performed, as well as determining whether or not the learning for the HMM is finished based on the number of learnings as described above.

In other words, in step S18, the structure adjustment unit 16 selects a division target and a mergence target from the states of the HMM stored in the model storage unit 14 and performs the structure adjustment for adjusting the structure of the HMM by dividing the division target and merging the mergence target. However, the evaluation unit 13 may determine that the learning for the HMM is finished if none of the division target and the mergence target are selected in the previously performed structure adjustment, and determine that the learning for the HMM is not finished if at least one of the division target and the mergence target is selected.

In addition, the evaluation unit 13 may determine that the learning for the HMM is finished if an operation unit (not shown) such as a keyboard is operated to finish the learning process by a user, or a predetermined time has elapsed from the starting of the learning process.

In step S15, if it is determined that the learning for the HMM is not finished, the evaluation unit 13 requests the time series data input unit 11 to resupply the observed time series data o to the parameter estimation unit 12, and the process goes to the step S16.

In step S16, the evaluation unit 13 evaluates an HMM after being updated (after parameters are estimated) based on a likelihood for the HMM after being updated from the parameter estimation unit 12, and, the process goes to step S17.

In other words, in step S16, the evaluation unit 13 obtains the increment L1-L2 of the likelihood L1 for the HMM after being updated with respect to the likelihood L2 for the HMM before being updated (immediately before the parameters are estimated), and evaluates the HMM after being updated based on whether or not the increment L1-L2 of the likelihood L1 for the HMM after being updated is smaller than a predetermined value.

If the increment L1-L2 of the likelihood L1 for the HMM after being updated is not smaller than the predetermined value, since new improvement in likelihood for the HMM can be expected by estimating parameters while maintaining the structure of the HMM as the current structure, the evaluation unit 13 evaluates that the HMM after being updated is not necessary for the structure adjustment.

On the other hand, if the increment L1-L2 of the likelihood L1 for the HMM after being updated is smaller than the predetermined value, since improvement in likelihood for the HMM may not be expected even if parameters are estimated while maintaining the structure of the HMM as the current structure, the evaluation unit 13 evaluates that the HMM after being updated is not necessary for the structure adjustment.

In step S17, the evaluation unit 13 determines whether or not to adjust the structure of the HMM based on the result of the evaluation for the HMM after being updated in previous step S16.

In step S17, if it is determined that the structure of the HMM is not adjusted, that is, the structure adjustment of the HMM after being updated is not necessary, the process returns to step S12 after step S18 is skipped.

In step S12, as described above, the parameter estimation unit 12 estimates new parameters of the HMM by the Baum-Welch algorithm, using the parameters of the HMM stored in the model storage unit 14 as initial values and using the observed time series data o from the time series data input unit 11 as learning data used to learn the HMM.

In other words, the time series data input unit 11 supplies the observed time series data o to the parameter estimation unit 12 in response to the request from the evaluation unit 13 which has determined that the learning for the HMM is not finished in step S15.

In step S12, as described above, the parameter estimation unit 12 estimates new parameters of the HMM by using the observed time series data o supplied from the time series data input unit 11 as learning data and by using the parameters of the HMM stored in the model storage unit 14 as initial values.

In addition, the parameter estimation unit 12 supplies and stores the new parameters of the HMM to and in the model storage unit 14 such that the HMM (parameters thereof) stored in the model storage unit 14 is updated, and, the same process is repeated therefrom.

On the other hand, in step S17, if it is determined that the structure of the HMM is adjusted, that is, the structure adjustment of the HMM after being updated is necessary, the evaluation unit 13 requests that the structure adjustment unit 16 perform structure adjustment, and the process goes to step S18.

In step S18, the structure adjustment unit 16 performs the structure adjustment for the HMM stored in the model storage unit 14 in response to the request from the evaluation unit 13.

In other words, in step S18, the structure adjustment unit 16 selects a division target and a mergence target from the states of the HMM stored in the model storage unit 14 and performs the structure adjustment for adjusting the structure of the HMM by dividing the division target and merging the mergence target.

Thereafter, the process returns to step S12 from step S18, and, the same process is repeated therefrom.

On the other hand, if it is determined that the learning for the HMM is finished in step S15, the evaluation unit 13 reads the HMM as the best model from the model buffer 15 via the structure adjustment unit 16, outputs the HMM as an HMM after being learned, and finishes the learning process.

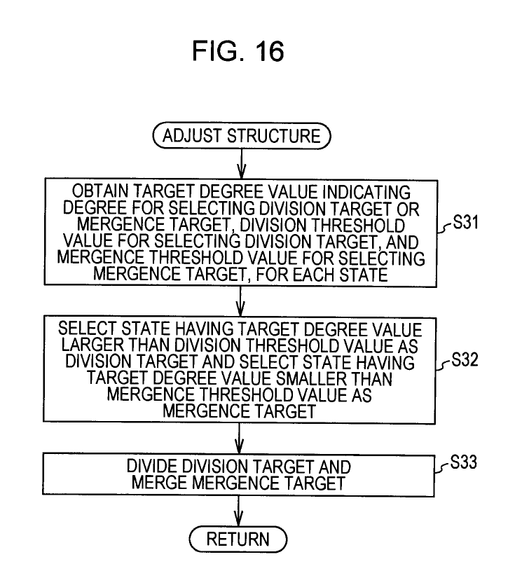

FIG. 16 is a flowchart illustrating the structure adjustment process performed by the structure adjustment unit 16 in step S18 in FIG. 15.

In step S31, the structure adjustment unit 16 notes each state of the HMM stored in the model storage unit 14 as a noted state, and obtains the average state probability, the eigen value difference, and the synthesis value as target degree values indicating a degree (of propriety) for selecting the noted state as a division target or a mergence target, for the noted state.

In addition, the structure adjustment unit 16 obtains, for example, an average value Vave and a standard deviation a of target degree values which are obtained for the respective states of the HMM, and obtains a value obtained by adding the standard deviation σ to the average value Vave as a division threshold value for selecting the division target, and obtains a value obtained by subtracting the standard deviation σ from the average value Vave as a mergence threshold value for selecting the mergence target.

Further, the process goes to step S32 from step S31, where the structure adjustment unit 16 selects a state having the target degree value larger than the division threshold value as the division target and selects a state having the target degree value smaller than the mergence threshold value as the mergence target from the states of the HMM stored in the model storage unit 14, and the process goes to step S33.

Here, if a state having the target degree value larger than the division threshold value does not exist, and a state having the target degree value smaller than the mergence threshold value does not exist among the states of the HMM stored in the model storage unit 14, none of the division target and the mergence target are selected in step S32. The process returns after skipping step S33.

In step S33, the structure adjustment unit 16 divides the state which is selected as the division target among the states of the HMM stored in the model storage unit 14 as described in FIG. 5, and merges the state which is selected as the mergence target as described in FIG. 6, and then the process returns.

### Simulation for Learning Process

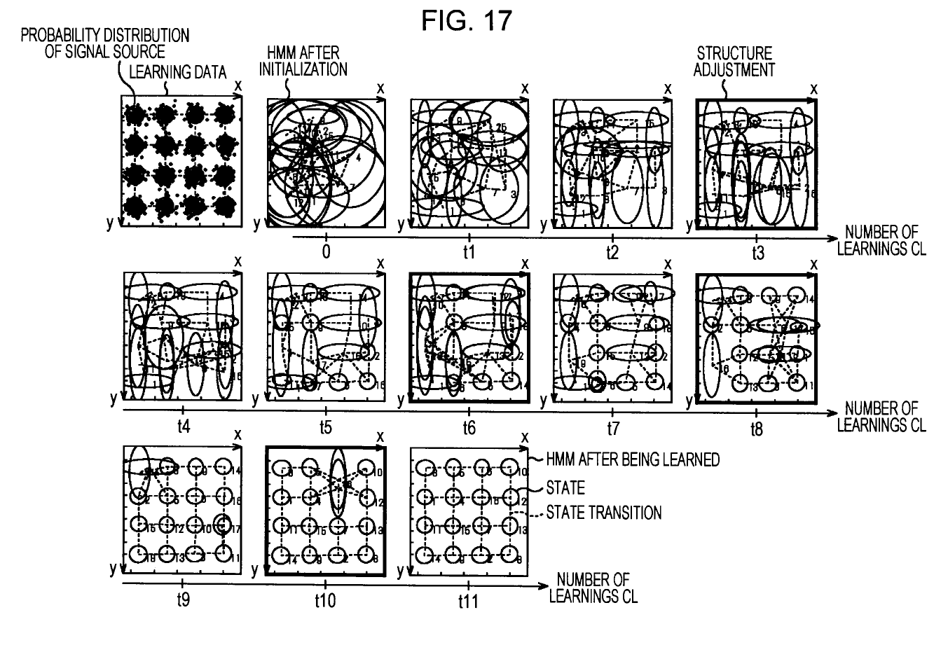

FIG. 17 is a diagram illustrating a first simulation for the learning process performed by the data processing device in FIG. 4.

In other words, FIG. 17 shows learning data used in the first simulation and an HMM for which learning (parameter update and structure adjustment) is performed using the learning data.

In the first simulation, the observed time series data described in FIG. 7 is used as the learning data.

In other words, in the first simulation, a signal source which appears at an arbitrary position on the two-dimensional space and outputs coordinates of the position is targeted as a modeling target, and the coordinates output by the signal source is used as an observed value o.

As described in FIG. 7, the signal source appears along sixteen normal distributions which have an average value of (coordinates) of each of sixteen points which are obtained by equally dividing a range from 0.2 to 0.8 at an interval of 0.2 in the x coordinate and equally dividing a range from 0.2 to 0.8 at an interval of 0.2 in the y coordinate on the two-dimensional space, and which have 0.00125 as a variance.

In the two-dimensional space showing the learning data in FIG. 17, in the same manner as FIG. 7, the sixteen circles denote probability distribution of a signal source (a position thereof) appearing along the normal distributions as described above. In other words, the center of the circle indicates an average value of the position (coordinates thereof) where the signal source appears, and the diameter of the circle indicates a variance of a position where the signal source appears.

A signal source randomly selects one normal distribution from the sixteen normal distributions and appears along the normal distribution. Further, the signal source outputs coordinates of the position where it appears, and repeats selecting a normal distribution again and appearing along the normal distribution.

However, in the first simulation, in the same manner as the case in FIG. 7, the selection of a normal distribution is limited so as to be performed from normal distributions transversely adjacent and normal distributions longitudinally adjacent to a previously selected normal distribution.

In other words, normal distributions (adjacent normal distributions) transversely and longitudinally adjacent to a previously selected normal distribution are referred to as adjacent normal distributions, and if a total number of the adjacent normal distributions is C, the adjacent normal distributions are all selected in the probability of 0.2, and the previously selected normal distribution is selected in the probability of 1-0.2C.

In the two-dimensional space showing the learning data in FIG. 17, the dotted lines connecting the circles denoting the normal distributions to each other indicates the limitation in the selection of normal distributions.

In addition, a point in the two-dimensional space showing the learning data in FIG. 17 indicates a position of coordinates output by the signal source, and, in the first simulation, time series of 1600 samples of the coordinates output by the signal source is used as the learning data.

Further, in the first simulation, the learning for the HMM which employs the normal distribution as the probability distribution bⱼ(o) of the state sⱼ using the above-described learning data is carried out.

In the two-dimensional space showing the HMM in FIG. 17, the circles (circles or ellipses) marked with the solid line indicate the state sᵢ of the HMM, and numbers added to the circles are indices of the state sᵢ indicated by the circles.

In addition, the indices of the state sᵢ use integers equal to or more than 1 in an ascending order. If the state sᵢ is removed by the state mergence, the index of the removed state sᵢ becomes a so-called missing number, but, if a new state is added by the subsequent state division, the index of the missing number is restored in an ascending order.

In addition, the center of the circle indicating the state sⱼ is an average value (a position indicated thereby) of the normal distribution which is the probability distribution bⱼ(o) of the state sⱼ, and the size (diameter) of the circle indicates the variance of the normal distribution which is the probability distribution bⱼ(o) of the state sⱼ.

The dotted line connecting the center of the circle denoting a certain state sᵢ to the center of the circle denoting another state sⱼ indicates state transitions between the states sᵢ and sⱼ of which either or both of the state transition probabilities aᵢⱼ and aⱼᵢ are equal to or more than a predetermined value.

In addition, the thick solid line frame surrounding the two-dimensional space showing the HMM in FIG. 17 means that the structure adjustment has been performed.

In addition, in the first simulation, the synthesis value Bᵢ is used as the target degree value, and 0.5 is used as the weight α when the synthesis value Bᵢ is obtained.

In addition, in the first simulation, as the HMM with an initial structure, an HMM having sixteen states in the number of states is used in which state transitions from each state are limited to a self transition and two-dimensional lattice-shaped state transitions.

Here, the two-dimensional lattice-shaped state transitions regarding the sixteen states mean state transitions from a noted state to states transversely and longitudinally adjacent to the noted state (transversely adjacent states and longitudinally adjacent states), for example, if it is assumed that, among the sixteen states s₁ to s₁₆, the states s₁ to s₄ are arranged in the first row, the states s₅ to s₈ are arranged in the second row, the states s₉ to s₁₆ are arranged in the third row, and the states s₁₃ to s₁₆ are arranged in the fourth row, in the two-dimensional lattice shape of 4×4 on the two-dimensional space.

By limiting the state transitions of the HMM, an amount of calculation necessary to estimate parameters of the HMM can be greatly reduced.

However, in the case where the state transitions of the HMM are limited, since the degree of freedom of the state transitions is lowered, parameters of such an HMM include a lot of local solutions (parameters of an HMM which has low likelihood of observing learning data) which are different from a correct solution and for which likelihood is low. In addition, it is difficult to prevent the local solutions only by the parameter estimation using the Baum-Welch algorithm.

In contrast, the data processing device in FIG. 4 performs the structure adjustment as well as the parameter estimation using the Baum-Welch algorithm, thereby obtaining better solutions as parameters of the HMM, that is, obtaining an HMM which more appropriately representing a modeling target.

In other words, in FIG. 17, the HMM when the number CL of learnings is 0 is an HMM with the initial structure.

Thereafter, as the number CL of learnings increases to t1 (>0) and t2 (>t1) (as the learning progresses), the parameters of the HMM converge due to the parameter estimation.

If the learning for the HMM is carried out only by the parameter estimation using the Baum-Welch algorithm, the learning for the HMM is finished by convergence of the parameters of the HMM.

In order to obtain better solutions (parameters of the HMM) than the parameters of the HMM after the convergence, it is necessary to change the initial structure or the initial parameters and perform the parameter estimation again.

On the other hand, the data processing device in FIG. 4 performs the structure adjustment if the increment of the likelihood for the HMM after the parameter estimation (being updated) becomes small due to the convergence of the parameters of the HMM.

In FIG. 17, when the number CL of learnings is t3 (>t2), the structure adjustment is performed.

After the structure adjustment, as the number CL of learnings increases to t4 (>t3) and t5 (>t4), the parameters of the HMM after the structure adjustment converge due to parameter estimation and the increment of the likelihood for the HMM after the parameter estimation becomes small again.

If the increment of the likelihood for the HMM after the parameter estimation becomes small, the structure adjustment is performed.

In FIG. 17, when the number CL of learnings is t6 (>t5), the structure adjustment is performed.

Hereinafter, in the same manner, the parameter estimation and the structure adjustment are performed.

In FIG. 17, when the number CL of learnings increases to t7 (>t6), t8 (>t7), t9 (>t8), and t10 (>t9) and then becomes t11 (>t10), the learning for the HMM is finished.

In addition, when the number CL of learnings is t8 and t10, the structure adjustment is performed.

In FIG. 17, in the HMM after the number CL of learnings becomes t11 and the learning is finished (HMM after being learned), the states correspond to probability distributions of the signal source, and the state transitions correspond to limitation in the selection of the normal distributions indicating the probability distribution in which the signal source appears. Therefore, it can be seen that the HMM appropriately representing the signal source is obtained.

In other words, in the structure adjustment, as described above, a state to be divided in order to obtain an HMM appropriately representing a signal source is selected as a division target and is divided, and a state to be merged in order to obtain an HMM appropriately representing a signal source is selected as a mergence target and is merged. Thus, it is possible to obtain the HMM appropriately representing the signal source.

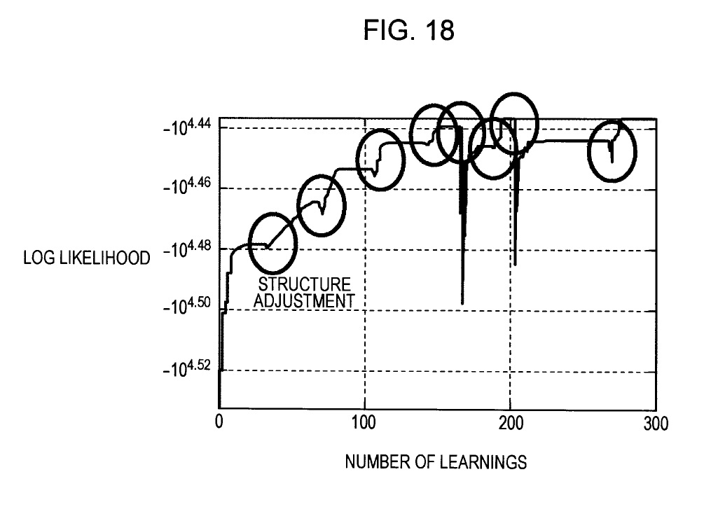

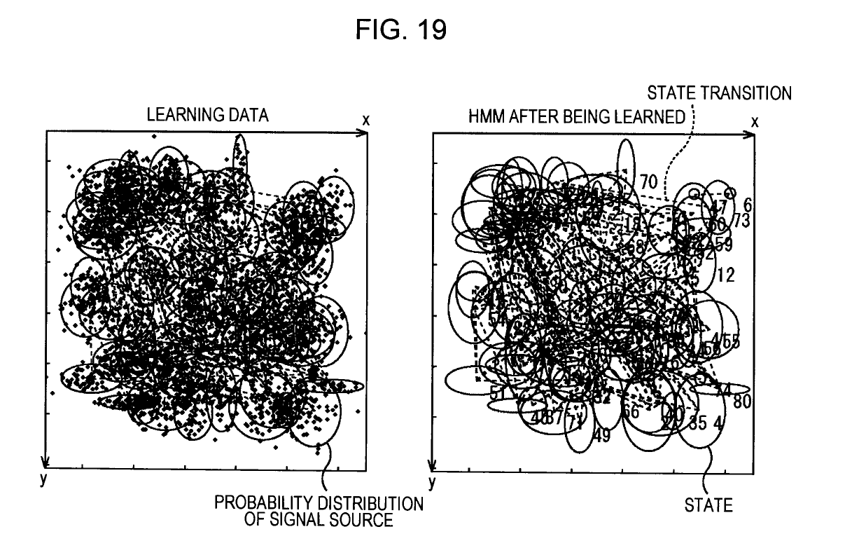

FIG. 18 is a diagram illustrating a relationship between the number of learnings and likelihood (log likelihood) for the HMM in the learning for the HMM as the first simulation.

The likelihood for the HMM increases as the learning progresses (as the number of learnings increases through the repetition of the parameter estimation), but reaches a lower peak only in the parameter estimation (a local solution can be obtained).

The data processing device in FIG. 4 performs the structure adjustment if the likelihood for the HMM becomes a lower peak. The likelihood for the HMM is temporarily lowered immediately after the structure adjustment is performed, but increases according to the progress of the learning, and reaches a lower peak again.

If the likelihood for the HMM becomes the lower peak, the structure adjustment is performed, and, hereinafter, the same process is performed, thereby obtaining an HMM having higher likelihood.

In addition, for example, in the structure adjustment, in a case where none of a division target and a mergence target are selected, and the likelihood for the HMM hardly increases but reaches a peak even if the parameter estimation is performed, the learning for the HMM is finished.

In the HMM after being learned, as described in FIG. 17, the states correspond to the probability distributions of the signal source, and the state transitions correspond to the limitation in the selection of the normal distributions indicating the probability distribution in which the signal source appears. Therefore, it can be seen that a state suitable to appropriately represent the signal source is selected as a division target or a mergence target, and the number of states constituting the HMM is appropriately adjusted by the structure adjustment.

In addition, it is possible to obtain an HMM with higher likelihood than an HMM obtained in the data processing device in FIG. 4 by performing the learning for an HMM which has many states and of which state transitions are not limited, thereby having a high degree of freedom, only using the parameter estimation.

However, in the HMM having the high degree of freedom, a so-called excessive learning is performed, and, so to speak, an irregular time series pattern which does not match with a time series pattern of time series data observed from a signal source is also obtained, and, it may not be said that the HMM which obtains such an irregular time series pattern (HMM which too sensitively represents variation in the time series data) appropriately represents the signal source.

FIG. 19 is a diagram illustrating a second simulation for the learning process performed by the data processing device in FIG. 4.

In other words, FIG. 19 shows learning data used in the second simulation and an HMM (HMM after being learned) for which learning (parameter update and structure adjustment) is performed using the learning data.

In the second simulation, in the same manner as the first simulation, a signal source which appears at an arbitrary position on the two-dimensional space and outputs coordinates of the position is targeted as a modeling target, and the coordinates output by the signal source are used as an observed value o.

However, in the second simulation, the signal source targeted as a modeling target becomes complicated as compared with in the first simulation.

In other words, in the second simulation, only eighty-one sets of x coordinates and y coordinates between 0 and 1 on the two-dimensional space are randomly generated, and the signal source appears along eighty-one normal distributions which respectively have eighty-one points (coordinates thereof), which are designated by x coordinates and y coordinates of eighty-one sets as average values.

In addition, variances of the eighty-one normal distributions are determined by randomly generating a value between 0 and 0.005.

In the two-dimensional space showing the learning data in FIG. 19, the solid line circle indicates a probability distribution of the signal source (position thereof) which appears along the above-described normal distribution. In other words, the center of the circle indicates an average value of positions (coordinates thereof) where the signal source appears, and the size (diameter) of the circle indicates a variance of the positions where the signal source appears.

The signal source randomly selects one normal distribution from the eighty-one normal distributions, and appears along the normal distribution. In addition, the signal source outputs coordinates of the position at which the signal source appears, and repeats selecting a normal distribution and appearing along the normal distribution.

However, in the second simulation as well, in the same manner as the case in FIG. 7, the selection of a normal distribution is limited so as to be performed from normal distributions transversely adjacent and normal distributions longitudinally adjacent to a previously selected normal distribution.

In other words, normal distributions (adjacent normal distributions) transversely and longitudinally adjacent to a previously selected normal distribution are referred to as adjacent normal distributions, and if a total number of the adjacent normal distributions is C, the adjacent normal distributions are all selected in the probability of 0.2, and the previously selected normal distribution is selected in the probability of 1-0.2C.

In the two-dimensional space showing the learning data in FIG. 19, the dotted lines connecting the circles denoting the normal distributions to each other indicates the limitation in the selection of normal distributions in the simulation.

In addition, in the second simulation, normal distributions transversely (or longitudinally) adjacent to a previously selected normal distribution are normal distributions corresponding to points transversely (or longitudinally) adjacent to a point corresponding to the previously selected normal distribution in a case where the eighty-one normal distributions correspond to points arranged in a lattice shape of 9×9 in the width×height.

In the two-dimensional space showing the learning data in FIG. 19, the points indicate coordinates of points output by the signal source, and, in the second simulation, time series of 8100 samples of the coordinates output by the signal source is used as the learning data.

Further, in the second simulation, the learning for the HMM which employs the normal distribution as the probability distribution bⱼ(o) of the state sⱼ using the above-described learning data is carried out.

In the two-dimensional space showing the HMM in FIG. 19, the circles (circles or ellipses) marked with the solid line indicate the state sᵢ of the HMM, and numbers added to the circles are indices i of the state sᵢ indicated by the circles.

In addition, the center of the circle indicating the state sⱼ is an average value (a position indicated thereby) of the normal distribution which is the probability distribution bⱼ(o) of the state sⱼ, and the size (diameter) of the circle indicates the variance of the normal distribution which is the probability distribution b (o) of the state sⱼ.

The dotted line connecting the center of the circle denoting a certain state sᵢ to the center of the circle denoting another state sⱼ indicates state transitions between the states sᵢ and sⱼ of which either or both of the state transition probabilities aᵢⱼ and aⱼᵢ is equal to or more than a predetermined value.

In addition, in the second simulation, in the same manner as the first simulation, the synthesis value Bᵢ is used as the target degree value, and 0.5 is used as the weight α when the synthesis value Bᵢ is obtained.

In addition, in the second simulation, as the HMM with an initial structure, an HMM having eighty-one states in the number of states is used in which state transitions from each state are limited to five state transitions of a self transition and state transitions to other four states. In addition, the state transition probability from each state is determined using random numbers.

In the HMM after being learned obtained in the second simulation as well, the states correspond to probability distributions of the signal source, and the state transitions correspond to limitation in the selection of the normal distributions indicating the probability distribution in which the signal source appears. Therefore, it can be also seen that the HMM appropriately representing the signal source is obtained.

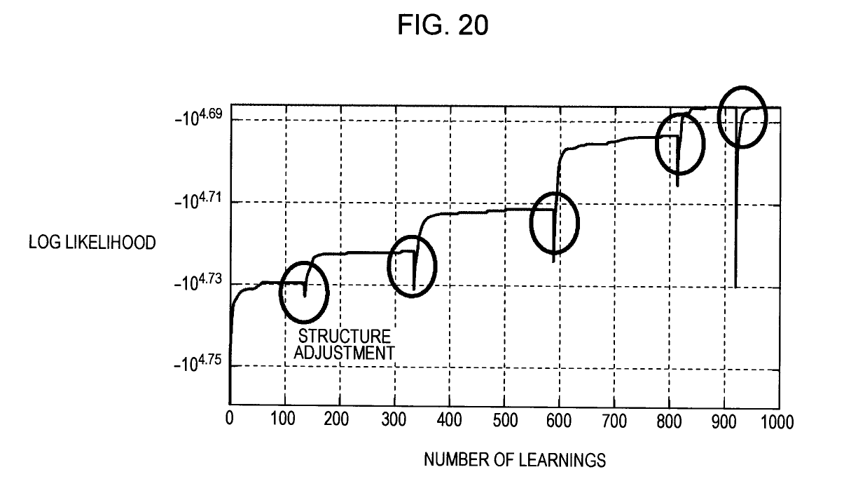

FIG. 20 is a diagram illustrating a relationship between the number of learnings and likelihood (log likelihood) for the HMM in the learning for the HMM as the second simulation.

In the second simulation as well, in the same manner as the first simulation, the parameter estimation and the structure adjustment are repeatedly performed, thereby obtaining an HMM having higher likelihood and appropriately representing a modeling target.

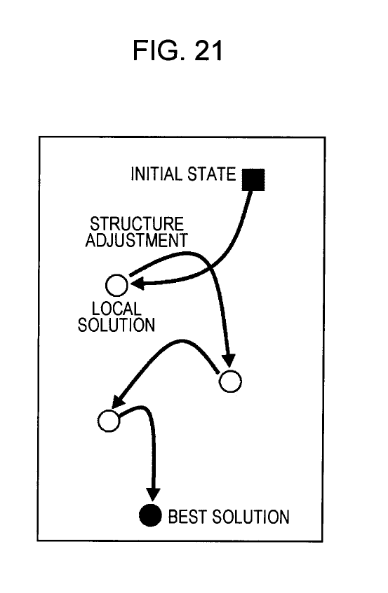

FIG. 21 is a diagram schematically illustrating a state where good solutions which are parameters of an HMM appropriately representing a modeling target are efficiently searched for inside a solution space in the learning process performed by the data processing device in FIG. 4.

In FIG. 21, solutions positioned in the lower part indicate better solutions.

Only in the parameter estimation, a parameter is entrapped into a local solution due to an initial structure or initial parameters of an HMM, and it is difficult to escape from the local solution.

In the learning process performed by the data processing device in FIG. 4, parameters of the HMM are entrapped into a local solution, and, as a result, if variation (increment) in likelihood for the HMM disappears due to the parameter estimation, the structure adjustment is performed.

The parameters of the HMM can escape from (a dent of) the local solution by the structure adjustment, and at that time, the likelihood for the HMM is temporarily lowered, but, due to the subsequent parameter estimation, the parameters of the HMM converge to a better solution than the local solution into which the parameters were entrapped previously.

In the learning process performed by the data processing device in FIG. 4, hereinafter, the same parameter estimation and structure adjustment are repeatedly performed, and thereby, even if the parameters of the HMM are entrapped into a local solution, there is convergence to a better solution after escaping from the local solution.

Therefore, according to the learning process performed by the data processing device in FIG. 4, it is possible to efficiently perform learning for obtaining a better solution (parameters of the HMM) which is obtained through retrial by changing the initial structure or the initial parameters only in the parameter estimation.

In addition, the parameter estimation may be performed by methods other than the Baum-Welch algorithm, that is, for example, a Monte-Carlo EM algorithm or an average field approximation.

In addition, in the data processing device in FIG. 4, after the learning for an HMM is carried out using certain observed time series data o as learning data, if the learning for the HMM is to be carried out using another observed time series data o′, that is, if a so-called additional learning for another observed time series data o′ is to be carried out, it is not necessary to initialize the HMM or to learn the HMM using the observed time series data o and o′ as learning data, but learning in which the observed time series data o′ is used as learning data may be carried out using the HMM after being learned using the observed time series data o as learning data.

### Description of Computer According to Embodiment

Next, the above-described series of processes may be performed by hardware or software. When a series of processes is performed by the software, programs constituting the software are installed in a general computer.

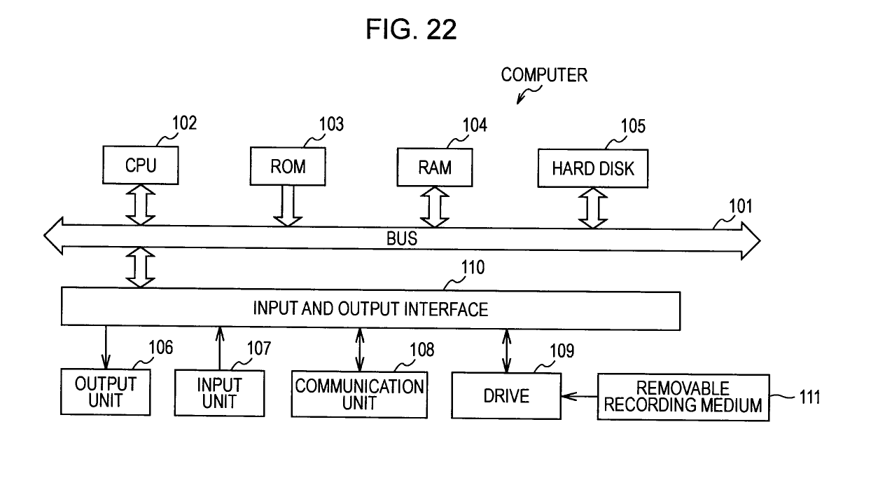

FIG. 22 shows a configuration example of a computer in which a program executing the series of processes is installed according to an embodiment.

The program may be recorded in advance in a hard disk 105 or a ROM 103 which is embedded in the computer as a recording medium.

Alternatively, the program may be stored (recorded) in a removable recording medium 111. The removable recording medium 111 may be provided as so-called package software. Here, examples of the removable recording medium 111 include a flexible disk, a CD-ROM (Compact Disc Read Only Memory), an MO (Magneto optical) disc, a DVD (Digital Versatile Disc), a magnetic disc, a semiconductor memory, and the like.

In addition, the program may not only be installed in the computer from the removable recording medium 111 as described above but may be also downloaded to the computer via a communication network or a broadcasting network and be installed in the embedded hard disk 105. In other words, the program may be transmitted to the computer in a wireless manner via an artificial satellite for digital satellite broadcasting, or in a wired manner via a network such as a LAN (Local Area Network) or the Internet.

The computer embeds a CPU (Central Processing Unit) 102 therein, and the CPU 102 is connected to an input and output interface 110 via a bus 101.

If commands are input from a user by an operation of an input unit 107 via the input and output interface 110, the CPU 102 executes the program stored in the ROM (Read Only Memory) 103 in response thereto. Alternatively, the CPU 102 loads the program stored in the hard disk 105 to the RAM (Random Access Memory) 104 to be executed.

Thereby, the CPU 102 performs the processes according to the above-described flowchart or the above-described configuration of the block diagram. The CPU 102 optionally, for example, outputs the processed result from an output unit 106, transmits the result from a communication unit 108, or records the result in the hard disk 105, via the input and output interface 110.

In addition, the input unit 107 includes a keyboard, a mouse, a microphone, and the like. The output unit 106 includes an LCD (Liquid Crystal Display), a speaker, and the like.

Here, in this specification, the processes which the computer performs according to the program may not follow the orders described in the flowchart in a time series. That is to say, the processes which the computer performs according to the program include processes performed in parallel or separately (for example, a parallel process, or a process using objects).

In addition, the program may be processed by a single computer (processor) or may be processed by a plurality of computers in a distributed manner. Also, the program may be executed after being transmitted to a computer positioned in a distant place.

The present application contains subject matter related to that disclosed in Japanese Priority Patent Application JP 2010-116092 filed in the Japan Patent Office on May 20, 2010, the entire contents of which are hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. A data processing device comprising:
a parameter estimation means that performs parameter estimation for estimating parameters of an HMM (Hidden Markov Model) using time series data; and
a structure adjustment means that selects a division target which is a state to be divided and a mergence target which is a state to be merged from states of the HMM, and performs structure adjustment for adjusting a structure of the HMM by dividing the division target and merging the mergence target,
wherein the structure adjustment means notes each state of the HMM as a noted state; obtains, for the noted state, a value corresponding to an eigen value difference which is a difference between a partial eigen value sum which is a sum of eigen values of a partial state transition matrix excluding a state transition probability from the noted state and a state transition probability to the noted state, from a state transition matrix having state transition probabilities from each state to each state of the HMM as components, and a total eigen value sum which is a sum of eigen values of the state transition matrix, as a target degree value indicating a degree for selecting the noted state as the division target or the mergence target; and selects a state having the target degree value larger than a division threshold value which is a threshold value larger than an average value of target degree values of all the states of the HMM, as the division target, and selects a state having the target degree value smaller than a mergence threshold value which is a threshold value smaller than an average value of target degree values of all the states of the HMM, as the mergence target.

2. The data processing device according to claim 1, wherein the structure adjustment means obtains an average state probability which is obtained by averaging a state probability of the noted state in a time direction when a sample of the time series data at each time is observed, and obtains a synthesis value obtained by synthesizing the eigen value difference of the noted state with the average state probability as a target degree value of the noted state.

3. The data processing device according to claim 1, further comprising an evaluation means that evaluates an HMM after parameter estimation and determines whether or not to perform the structure adjustment based on a result of the estimation of the HMM.

4. The data processing device according to claim 3, wherein the evaluation means determines that the structure adjustment is performed if an increment of likelihood in which the time series data is observed in an HMM after parameter estimation with respect to a likelihood in which the time series data is observed in an HMM before the parameter estimation is smaller than a predetermined value.

5. The data processing device according to claim 1, wherein the division threshold value is a value larger than an average value of target degree values of all the states of the HMM by a standard deviation of the target degree values of all the states of the HMM, and the mergence threshold value is a value smaller than an average value of target degree values of all the states of the HMM by a standard deviation of the target degree values of all the states of the HMM.

6. The data processing device according to claim 1, wherein in the division of the division target, the structure adjustment means adds a new state, adds state transitions between the new state and other states having state transitions with the division target, a self transition, and a state transition between the new state and the division target as state transitions with the new state, and
wherein in the mergence of the mergence target, the structure adjustment means removes the mergence target, and adds state transitions between each of other states having state transitions with the mergence target.

7. A data processing method comprising the steps of:
causing a data processing device to perform parameter estimation for estimating parameters of an HMM (Hidden Markov Model) using time series data; and to select a division target which is a state to be divided and a mergence target which is a state to be merged from states of the HMM, and to perform structure adjustment for adjusting a structure of the HMM by dividing the division target and merging the mergence target,
wherein the structure adjustment step includes
noting each state of the HMM as a noted state;
obtaining, for the noted state, a value corresponding to an eigen value difference which is a difference between a partial eigen value sum which is a sum of eigen values of a partial state transition matrix excluding a state transition probability from the noted state and a state transition probability to the noted state from a state transition matrix having state transition probabilities from each state to each state of the HMM as components, and a total eigen value sum which is a sum of eigen values of the state transition matrix, as a target degree value indicating a degree for selecting the noted state as the division target or the mergence target; and
selecting a state having the target degree value larger than a division threshold value which is a threshold value larger than an average value of target degree values of all the states of the HMM, as the division target, and selecting a state having the target degree value smaller than a mergence threshold value which is a threshold value smaller than an average value of target degree values of all the states of the HMM, as the mergence target.

8. A program enabling a computer to function as:
a parameter estimation means that performs parameter estimation for estimating parameters of an HMM (Hidden Markov Model) using time series data; and
a structure adjustment means that selects a division target which is a state to be divided and a mergence target which is a state to be merged from states of the HMM, and performs structure adjustment for adjusting a structure of the HMM by dividing the division target and merging the mergence target,
wherein the structure adjustment means notes each state of the HMM as a noted state; obtains, for the noted state, a value corresponding to an eigen value difference which is a difference between a partial eigen value sum which is a sum of eigen values of a partial state transition matrix excluding a state transition probability from the noted state and a state transition probability to the noted state, from a state transition matrix having state transition probabilities from each state to each state of the HMM as components, and a total eigen value sum which is a sum of eigen values of the state transition matrix, as a target degree value indicating a degree for selecting the noted state as the division target or the mergence target; and selects a state having the target degree value larger than a division threshold value which is a threshold value larger than an average value of target degree values of all the states of the HMM, as the division target, and selects a state having the target degree value smaller than a mergence threshold value which is a threshold value smaller than an average value of target degree values of all the states of the HMM, as the mergence target.

9. A data processing device comprising:
a parameter estimation means that performs parameter estimation for estimating parameters of an HMM (Hidden Markov Model) using time series data; and
a structure adjustment means that selects a division target which is a state to be divided and a mergence target which is a state to be merged from states of the HMM, and performs structure adjustment for adjusting a structure of the HMM by dividing the division target and merging the mergence target,
wherein the structure adjustment means notes each state of the HMM as a noted state; obtains, for the noted state, an average state probability which is obtained by averaging a state probability of the noted state in a time direction when a sample of the time series data at each time is observed, as a target degree value indicating a degree for selecting the noted state as the division target or the mergence target; and selects a state having the target degree value larger than a division threshold value which is a threshold value larger than an average value of target degree values of all the states of the HMM, as the division target, and selects a state having the target degree value smaller than a mergence threshold value which is a threshold value smaller than an average value of target degree values of all the states of the HMM, as the mergence target.

10. The data processing device according to claim 9, further comprising an evaluation means that evaluates an HMM after parameter estimation and determines whether or not to perform the structure adjustment based on a result of the estimation of the HMM.

11. The data processing device according to claim 10, wherein the evaluation means determines that the structure adjustment is performed if an increment of likelihood in which the time series data is observed in an HMM after parameter estimation with respect to a likelihood in which the time series data is observed in an HMM before the parameter estimation is smaller than a predetermined value.

12. The data processing device according to claim 9, wherein the division threshold value is a value larger than an average value of target degree values of all the states of the HMM by a standard deviation of the target degree values of all the states of the HMM, and the mergence threshold value is a value smaller than an average value of target degree values of all the states of the HMM by a standard deviation of the target degree values of all the states of the HMM.

13. The data processing device according to claim 9, wherein in the division of the division target, the structure adjustment means adds a new state, adds state transitions between the new state and other states having state transitions with the division target, a self transition, and a state transition between the new state and the division target as state transitions with the new state, and
wherein in the mergence of the mergence target, the structure adjustment means removes the mergence target, and adds state transitions between each of other states having state transitions with the mergence target.

14. A data processing method comprising the steps of:
causing a data processing device to perform parameter estimation for estimating parameters of an HMM (Hidden Markov Model) using time series data; and to select a division target which is a state to be divided and a mergence target which is a state to be merged from states of the HMM, and to perform structure adjustment for adjusting a structure of the HMM by dividing the division target and merging the mergence target,
wherein the structure adjustment step includes
noting each state of the HMM as a noted state;
obtaining, for the noted state, an average state probability which is obtained by averaging a state probability of the noted state in a time direction when a sample of the time series data at each time is observed, as a target degree value indicating a degree for selecting the noted state as the division target or the mergence target; and
selecting a state having the target degree value larger than a division threshold value which is a threshold value larger than an average value of target degree values of all the states of the HMM, as the division target, and selecting a state having the target degree value smaller than a mergence threshold value which is a threshold value smaller than an average value of target degree values of all the states of the HMM, as the mergence target.

15. A program enabling a computer to function as:
a parameter estimation means that performs parameter estimation for estimating parameters of an HMM (Hidden Markov Model) using time series data; and
a structure adjustment means that selects a division target which is a state to be divided and a mergence target which is a state to be merged from states of the HMM, and performs structure adjustment for adjusting a structure of the HMM by dividing the division target and merging the mergence target,
wherein the structure adjustment means notes each state of the HMM as a noted state; obtains, for the noted state, an average state probability which is obtained by averaging a state probability of the noted state in a time direction when a sample of the time series data at each time is observed, as a target degree value indicating a degree for selecting the noted state as the division target or the mergence target; and selects a state having the target degree value larger than a division threshold value which is a threshold value larger than an average value of target degree values of all the states of the HMM, as the division target, and selects a state having the target degree value smaller than a mergence threshold value which is a threshold value smaller than an average value of target degree values of all the states of the HMM, as the mergence target.

16. A data processing device comprising:
a parameter estimation unit that performs parameter estimation for estimating parameters of an HMM (Hidden Markov Model) using time series data; and
a structure adjustment unit that selects a division target which is a state to be divided and a mergence target which is a state to be merged from states of the HMM, and performs structure adjustment for adjusting a structure of the HMM by dividing the division target and merging the mergence target,
wherein the structure adjustment unit notes each state of the HMM as a noted state; obtains, for the noted state, a value corresponding to an eigen value difference which is a difference between a partial eigen value sum which is a sum of eigen values of a partial state transition matrix excluding a state transition probability from the noted state and a state transition probability to the noted state from a state transition matrix having state transition probabilities from each state to each state of the HMM as components, and a total eigen value sum which is a sum of eigen values of the state transition matrix, as a target degree value indicating a degree for selecting the noted state as the division target or the mergence target; and selects a state having the target degree value larger than a division threshold value which is a threshold value larger than an average value of target degree values of all the states of the HMM, as the division target, and selects a state having the target degree value smaller than a mergence threshold value which is a threshold value smaller than an average value of target degree values of all the states of the HMM, as the mergence target.

17. A data processing device comprising:
a parameter estimation unit that performs parameter estimation for estimating parameters of an HMM (Hidden Markov Model) using time series data; and
a structure adjustment unit that selects a division target which is a state to be divided and a mergence target which is a state to be merged from states of the HMM, and performs structure adjustment for adjusting a structure of the HMM by dividing the division target and merging the mergence target,
wherein the structure adjustment unit notes each state of the HMM as a noted state; obtains, for the noted state, an average state probability which is obtained by averaging a state probability of the noted state in a time direction when a sample of the time series data at each time is observed, as a target degree value indicating a degree for selecting the noted state as the division target or the mergence target; and selects a state having the target degree value larger than a division threshold value which is a threshold value larger than an average value of target degree values of all the states of the HMM, as the division target, and selects a state having the target degree value smaller than a mergence threshold value which is a threshold value smaller than an average value of target degree values of all the states of the HMM, as the mergence target.
